(19) United States
(12) Patent Application Publication
(10) Pub. No.: US 2025/0003204 A1
(43) Pub. Date: Jan. 2, 2025

(54) WATER SUPPLY DEVICE AND FAUCET INCLUDING SAME

(71) Applicant: LG ELECTRONICS INC., Seoul (KR)

(72) Inventors: Duchan KI, Seoul (KR); Junho LEE, Seoul (KR); Joon Ho PYO, Seoul (KR)

(21) Appl. No.: 18/673,832

(22) Filed: May 24, 2024

(30) Foreign Application Priority Data
Jun. 29, 2023 (KR) 10-2023-0084423
Jan. 29, 2024 (KR) 10-2024-0013154

(51) Int. Cl. E03C 1/05; C02F 1/00

(52) U.S. Cl. CPC E03C 1/055; C02F 1/003; C02F 2307/06

(57) ABSTRACT

Proposed are a water supply device and a faucet including the same. The water supply device may include a casing having an installation space provided therein. A flow path guide pack may be arranged in the installation space. An inlet through which water is introduced from the outside and an outlet through which water is discharged to the outside may be provided in the flow path guide pack. The flow path guide pack may include a first flow path body and a second flow path body coupled to the first flow path body. In this case, a plurality of flow paths may be formed between the first flow path body and the second flow path body. The flow paths may form paths independent of the installation space.

### CROSS-REFERENCE TO RELATED APPLICATION(S)

This application claims priority under 35 U.S.C. § 119 to Korean Application Nos. 10-2023-0084423 filed on Jun. 2, 2023, and 10-2024-0013454 filed on Jan. 29, 2024, whose entire disclosures are hereby incorporated by reference.

### BACKGROUND

### 1. Field

The present disclosure relates to a water supply device and a faucet.

### 2. Background

A water supply device is a device for supplying water to a user. When a user operates the water supply device, water stored in the water supply device or raw water supplied from outside may be supplied to the user through the water supply device. An example of the water supply device is a faucet used in a bathroom or kitchen.

The faucet may supply cold water and hot water from externally supplied raw water to a user. The faucet may provide a user with either cold water or hot water, or a mixture of cold water and hot water. Recently, a device such as a filter or a thermostat has been mounted inside the faucet.

Accordingly, a plurality of flow paths may be provided inside the faucet to mix the raw water or allow the raw water to pass through a device such as the filter or the thermostat. The plurality of flow paths may be implemented as a plurality of hoses. However, the plurality of hoses complicates the structure of the faucet and increases the number of parts, thereby reducing manufacturing convenience. In addition, each of the hoses has a small flow path cross-sectional area compared to an overall volume, which is disadvantageous in securing a large flow rate and causes the problem of the flow path being blocked when the hose is excessively bent.

As another example, a faucet may be made of a casting. For example, a faucet may be molded of a casting made of brass. Accordingly, the faucet made of a casting is high in manufacturing cost, and due to the nature of a material thereof, post-processing thereof is not easy, so there is a problem with a high defect rate during a manufacturing process. In addition, a faucet made of a casting is heavy, so when the faucet is installed on a wall surface, the faucet has a problem of reduced stability due to a large weight thereof.

To solve this problem, a faucet may be made of a resin material. Korean Utility Model Registration No. 20-0491186 (Prior Art 1) discloses a technology to create a faucet by thermally fusing two parts made of ABS resin. U.S. Pat. No. 9,403,304 B2 (Prior Art 2) discloses a technology in which resin parts constituting a coupler of a faucet are thermally fused and coupled to each other.

However, in Prior Art 1 and Prior Art 2, flow paths are formed integrally inside the main body of a faucet, and thus it is difficult to implement complex flow paths, and when the flow paths are damaged, the entire faucet is required to be replaced. In addition, in Prior Art 1 and Prior Art 2, when adding other parts (a filter or a thermostat, etc.) to the inside of a faucet body, flow paths to transfer water to the other parts are also required to be implemented in the faucet body, so the overall volume of the faucet is required to be very large.

Korean Patent Application Publication No. 10-2018-0015930 (Prior Art 3) discloses a dishwasher having a water jacket provided inside. The water jacket includes two parts joined by heat fusion, and has a storage part inside to store washing water. However, in Prior Art 3, the storage part is required to be included, thereby causing a large volume, and the function of mixing cold and hot water like a typical faucet is not provided, thereby making application to the faucet difficult.

Meanwhile, in order to simplify the structure of the faucet body, the filter may be installed in a replaceable form on a shower head connected to the faucet. However, when the faucet is provided with multiple water outlets, the number of filters is also required to be increased. For example, when a plurality of water outlets, such as a handheld showerhead, a rainfall water outlet, and a bathtub water outlet, are connected to the faucet, filters are required to be placed at the water outlets, respectively, so there is a problem in that the number of filters increases.

Additionally, the filter provided in the shower head, etc. is exposed to the outside and spoils the aesthetics. In addition, each of the outlets, such as shower heads has limitation in a size, and thus the filter is required to be miniaturized, and the replacement cycle of the filter is decreased.

In addition, recently, a technology to supply power to a display by mounting a water-flow generator inside the faucet has been developed. Korean Patent No. 10-2147222 (Prior Art 4) and Korean Patent Application Publication No. 10-2022-0140919 (Prior Art 5) disclose a technology to measure water quality or emit LEDs by mounting a generator inside a shower. In Prior Art 4 and Prior Art 5, since the generator is arranged on the showerhead side rather than in a faucet body, a function to utilize generated power is limited, and it is difficult to transmit the generated power to the faucet body. The generator may be installed in the faucet body, but in this case, the flow path structure of the faucet body may be more complicated.

In addition, when impurities contained in water supplied to the water-flow generator adhere to the inside of the water-flow generator, the water-flow generator may be damaged.

### DOCUMENTS OF RELATED ART

(Patent Document 1) Korean Utility Model Registration No. 20-0491186 Prior Art 1
(Patent Document 2) U.S. Pat. No. 9,403,304 B2 (Prior Art 2)
(Patent Document 3) Korean Patent Application Publication No. 10-2018-0015930 (Prior Art 3)
(Patent Document 4) Korean Patent No. 10-2147222 (Prior Art 4)
(Patent Document 5) Korean Patent Application Publication No. 10-2022-0140919 (Prior Art 5)

### BRIEF DESCRIPTION OF THE DRAWINGS

The embodiments will be described in detail with reference to the following drawings in which like reference numerals refer to like elements wherein:

FIG. 1 is an example view illustrating the structure of a faucet to which a water supply device according to a first embodiment of the present disclosure is applied;

FIG. 2 is a side view illustrating a state in which the water supply device according to the first embodiment of the present disclosure is installed on a wall surface;

FIG. 3 is a bottom view illustrating the structure of the water supply device according to the first embodiment of the present disclosure;

FIG. 4 is an exploded perspective view illustrating components constituting the water supply device according to the first embodiment of the present disclosure;

FIG. 5 is an exploded perspective view of the remaining components with a casing omitted in the water supply device according to the present disclosure according to the first embodiment;

FIG. 6 is an exploded perspective view of the remaining components with the casing omitted in the water supply device of the present disclosure according to the first embodiment viewed at an angle different from FIG. 5;

FIG. 7 is a front view illustrating the remaining components with the casing omitted in the water supply device according to the present disclosure according to the first embodiment;

FIG. 8 is a plan view illustrating the remaining components with the casing omitted in the water supply device according to the present disclosure according to the first embodiment;

FIG. 9 is a bottom view illustrating the remaining components with the casing omitted in the water supply device of the present disclosure according to the first embodiment of the casing;

FIG. 10 is an exploded perspective view of the structure of a flow path guide pack and a reinforcing plate constituting the water supply device of the present disclosure according to the first embodiment;

FIG. 11 is an exploded perspective view of the structure of the flow path guide pack and the reinforcing plate constituting the water supply device of the present disclosure according to the first embodiment viewed at an angle different from FIG. 10;

FIG. 12 is an exploded perspective view of the flow path guide pack constituting the water supply device of the present disclosure according to the first embodiment;

FIG. 13 is a cross-sectional view taken along line XIII-XIII′ of FIG. 4;

FIG. 14 is a front view illustrating mixed water flowing along flow paths provided in a first flow path body of the flow path guide pack constituting the water supply device of the present disclosure according to the first embodiment;

FIG. 15 is a front view illustrating cold water flowing along the flow paths provided in the first flow path body of the flow path guide pack constituting the water supply device of the present disclosure according to the first embodiment;

FIG. 16 is a front view illustrating hot water flowing along the flow paths provided in the first flow path body of the flow path guide pack constituting the water supply device of the present disclosure according to the first embodiment;

FIG. 17 is a schematic block diagram of a connection structure between the flow path guide pack and other components constituting the water supply device of the present disclosure according to the first embodiment;

FIG. 18 an enlarged plan view of the structure of a portion of the first flow path body of the flow path guide pack constituting the water supply device of the present disclosure according to the first embodiment;

FIG. 19 is a perspective view illustrating the exploded structure of the filter constituting the water supply device of the present disclosure according to the first embodiment;

FIG. 20 is a cross-sectional view the present disclosure according to the first embodiment;

FIG. 21 is a cross-sectional view taken along line XXI-XXI′ of FIG. 7;

FIG. 22 is a cross-sectional view taken along line XXII-XXII′ of FIG. 7;

FIG. 23 is a cross-sectional view taken along line XXIII-XXIII′ of FIG. 8;

FIG. 24 is an exploded perspective view illustrating the structure of a generator and a water discharge selector constituting the water supply device of the present disclosure according to the first embodiment;

FIG. 25 is a perspective view illustrating the structure of the generator and the water discharge selector constituting the water supply device of the present disclosure according to the first embodiment;

FIG. 26 is a perspective view illustrating the structure of the generator and the water discharge selector, in which a third selection lever is manipulated, constituting the water supply device of the present disclosure according to the first embodiment.

FIG. 27 is a cross-sectional view illustrating the internal structure of the water discharge selector constituting the water supply device of the present disclosure according to the first embodiment;

FIG. 28 is a perspective view illustrating the structure of a selector cover and a movement guide among the components of the water discharge selector constituting the water supply device of the present disclosure according to the first embodiment;

FIG. 29 is a cross-sectional view taken along line XXIX-XXIX′ of FIG. 28;

FIG. 30 is a perspective view illustrating the water supply device according to the second embodiment of the present disclosure;

FIG. 31 is a perspective view illustrating a third embodiment of the water supply device according to the present disclosure;

FIG. 32 is a front view illustrating the structure of the first flow path body of the flow path guide pack constituting the water supply device according to the present disclosure of the third embodiment;

FIG. 33 is a front view illustrating the structure of a first flow path body of a flow path guide pack constituting the water supply device according to a fourth embodiment of the present disclosure;

FIG. 34 is a front view illustrating the structure of a first flow path body of a flow path guide pack constituting a water supply device according to a fifth embodiment of the present disclosure;

FIG. 35 is a perspective view illustrating the structure of a flow path guide pack constituting a water supply device according to a sixth embodiment of the present disclosure; and

FIG. 36 is a cross-sectional view illustrating the structure of a flow path guide pack constituting a water supply device according to a seventh embodiment of the present disclosure.

### DETAILED DESCRIPTION

Below, some embodiments of the present disclosure are described in detail through illustrative drawings. When adding reference numerals to components in each drawing, it should be noted that identical components are given the same reference numerals as much as possible even if they are shown in different drawings. Additionally, when explaining an example of the present disclosure, if a detailed description of the related known structure or function is determined to impede understanding of the embodiments of the present disclosure, the detailed description thereof is omitted.

The present disclosure relates to a water supply device 10. The water supply device 10 of the present disclosure may provide raw water supplied from an external water source by treating the raw water in various ways. The water supply device 10 may be applied to a faucet or other water supply devices. Here, the faucet may include a faucet used in a bathroom, such as a faucet for a shower, and a faucet used in a kitchen, such as a faucet for a sink. Additionally, the faucet may be used as an outdoor faucet in addition to as an indoor faucet. The water supply device 10 may also be applied to a home appliance that supplies water, such as a water purifier.

Here, raw water, which is water supplied from the outside, may be tap water. More specifically, the raw water may include cold water and hot water. For reference, hereinafter, raw water refers to water introduced from the outside, mixed water refers to the mixed water of the cold water and the hot water, controlled water refers to water whose flow rate is controlled by a flow rate controller 150, and purified water refers to water from which impurities have been filtered out by a filter 160.

The water supply device 10 of the present disclosure may provide functions such as mixing of cold water and hot water, purification of water, power supply through a generator 170, information transmission through a display 70, data reception/sending through a communication means, automatic control through a control device, or water discharge through a plurality of water outlets. Hereinafter, description will focus on the structure of the flow path guide pack 100 disposed inside the water supply device 10.

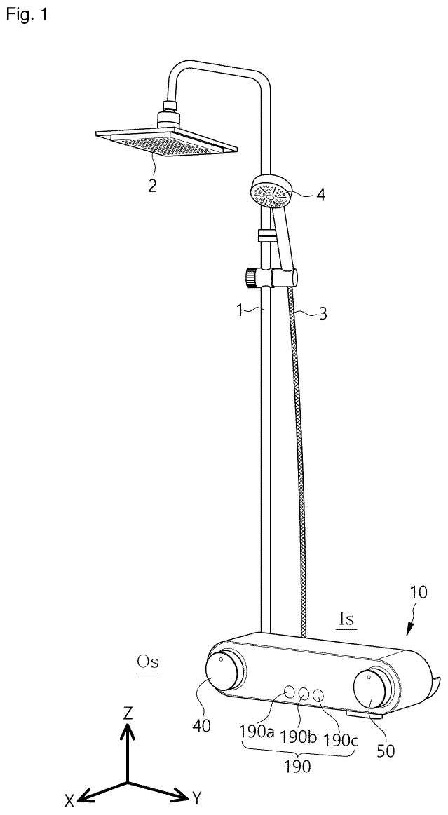

For reference, below, the front-to-rear direction of the water supply device 10 indicates the X-axis direction of FIG. 1. The left-to-right direction of the water supply device 10 indicates the Y-axis direction of FIG. 1. The upper side and lower side direction of the water supply device 10 indicates the Z-axis direction of FIG. 1. In addition, the front side of the water supply device 10 refers to a side in front of the water supply device 10, which is far from an installation surface W, and is marked with Os in FIG. 1. The rear side of the water supply device 10 refers to a side thereof directed to the installation surface W, and is marked with Is in FIG. 1.

Referring to FIG. 1, the water supply device 10 is illustrated to be used as a faucet for shower. A shower may include a first water discharge pipe 1, and a rainfall shower head 2 connected to the first water discharge pipe 1. The shower may include a handheld shower head 4 connected to a second water discharge pipe 3. The second water discharge pipe 3 may be made of a flexible hose material.

The rainfall shower head 2 and the handheld shower head 4 may receive water from the water supply device 10. The water supply device 10 may receive raw water from the outside and transmit the raw water to the rainfall shower head 2 and the handheld shower head 4. Although not shown in FIG. 1, the water supply device 10 may include a lower water outlet 25 (see FIG. 3) for discharging water into a bathtub. Hereinafter, the rainfall shower head 2 will be referred to as a first water discharge part, the handheld shower head 4 will be referred to as a second water discharge part, and the lower water outlet 25 will be referred to as a third water discharge part.

Accordingly, in this embodiment, the water supply device 10 may include a plurality of water discharge parts. Here, the water discharge parts may include the rainfall shower head 2, the handheld shower head 4, and the lower water outlet 25. The water supply device 10 may branch water inside and may transmit the water to any one of the plurality of water discharge parts or to the plurality of water discharge parts.

FIG. 1 illustrates a first knob 40 of a thermostat 140 to control the temperature of water. When the first knob 40 rotates, the thermostat 140 may operate and mixed water including hot and cold water may be discharged, or hot water or cold water may be discharged without mixing with each other. The water supply device 10 may further include a second knob 50 separately from the first knob 40. The second knob 50 is used to operate the flow rate controller 150 for controlling the flow rate of discharged water. When the second knob 50 is rotated, a discharged flow rate may be controlled.

In addition to the first knob 40 and the second knob 50, the water supply device 10 may include selection levers 190. The selection levers 190 may be connected to a water discharge selector 180 to be described below. The water discharge selector 180 allows a user to select which water discharge part among the plurality of water discharge parts to discharge water. In this embodiment, the water discharge selector 180 may include a total of three selection levers 190. The three selection levers 190 may allow water to be discharged to the rainfall shower head 2, the handheld shower head 4, and the lower water outlet 25, respectively.

The selection levers 190 may be placed between the thermostat 140 and the flow rate controller 150. The thermostat 140 and the flow rate controller 150 may be respectively arranged on opposite front ends of the water supply device 10. The selection levers 190 may be arranged between the thermostat 140 and the flow rate controller 150. In this case, the water supply device 10 may provide a user with a unified aesthetics through a symmetrical structure thereof. The thermostat 140, the flow rate controller 150, and the water discharge selector 180 will be described in detail below.

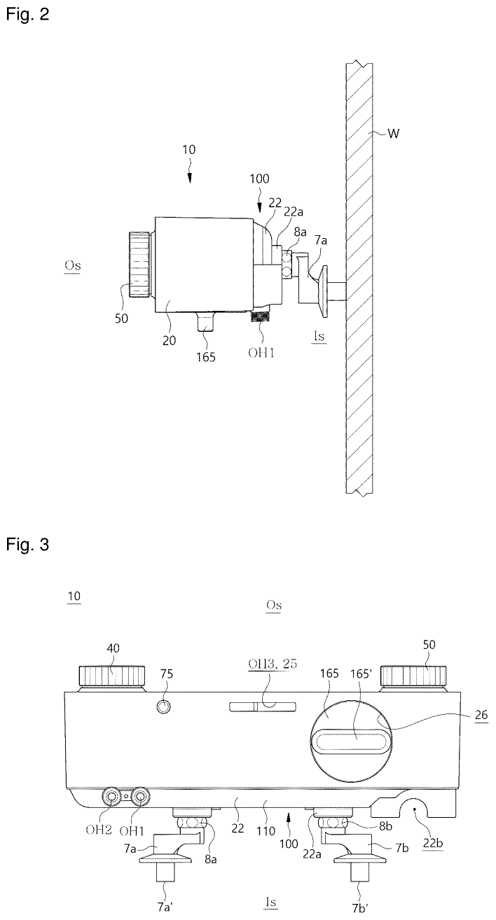

Referring to FIG. 2, the water supply device 10 is shown to be installed on a wall surface, which is the installation surface W. In this way, the rear surface of the water supply device 10 may face the installation surface W, and the water supply device 10 may protrude from the installation surface W. The water supply device 10 may be fixed to the installation surface W through installation adapters 7a and 7b for wall mount. Accordingly, a large load due to the weight of the water supply device 10 may be concentrated on the installation adapters 7a and 7b. In this embodiment, as will be described below, the load applied to the installation adapters 7a and 7b may be reduced through the structure of the flow path guide pack 100, the arrangement of parts thereof, and a reinforcing plate 130 thereof. For another example, the water supply device 10 may be stored in a storage part recessed in a wall surface. For still another example, the lower part of the water supply device 10 may be supported by the installation adapters 7a and 7b connected to the lower part of the water supply device 10.

As illustrated in FIGS. 2 and 3, on the lower portion of the water supply device 10, outlets OH1, OH2, and OH3 and a handle 165′ of the filter 160, which will be described later, may be exposed. A user may hold the handle 165′ and separate and replace a filter part 163, which constitutes the filter 160. In this embodiment, the filter part 163 may be mounted/detached in a vertical direction, and this structure will be described again below.

Referring to FIG. 3 showing the lower side of the water supply device 10, the plurality of outlets OH1, OH2, and OH3 may be open on the lower side of the water supply device 10. The plurality of outlets OH1, OH2, and OH3 may include a first outlet OH1, a second outlet OH2, and a third outlet OH3. Separate hoses may be connected to the first outlet OH1 and the second outlet OH2. In this embodiment, the first outlet OH1 and the second outlet OH2 are arranged adjacent to each other, but in another example, the first outlet OH1 and the second outlet OH2 may be spaced apart from each other.

The first outlet OH1 and the second outlet OH2 may be disposed at a position close to the rear of the water supply device 10. On the basis of FIG. 3, the first outlet OH1 and the second outlet OH2 may be disposed on the lower side of the water supply device 10. That is, the first outlet OH1 and the second outlet OH2 may be disposed close to the installation surface W. In this case, when hoses are connected to the first outlet OH1 and the second outlet OH2, torque applied to the installation adapters 7a and 7b may be reduced due to the weight of the hoses.

In this embodiment, the first outlet OH1 and the second outlet OH2 may be open in a second direction different from a first direction, which is a direction in which a first flow path body 110 and a second flow path body 120 are coupled to each other. The first direction is the same as the X-axis direction of FIG. 1, and the second direction is a direction orthogonal to the first direction (the Z-axis direction of FIG. 1) or may be a direction extending obliquely from the direction orthogonal to the first direction.

The third outlet OH3 may not be connected to a separate hose but may be open downward. Water discharged through the third outlet OH3 may be discharged toward the floor. When a bathtub is placed under the third outlet OH3, the third outlet OH3 may be the lower water outlet 25, and when a sink bowl is placed under the third outlet OH3, the third outlet OH3 may be a sink bowl outlet.

The handle 165′ of the filter 160 described above on the lower part of the water supply device 10 may be exposed. The handle 165′ may protrude from a filter cover 165. A user may rotate the handle 165′ to separate the filter part 163 including the filter cover 165 from the water supply device 10 or mount the filter part 163 to the water supply device 10.

Reference numeral 75 denotes a manipulation button 75. The manipulation button 75 may be used to manipulate the control device (not shown) disposed inside the water supply device 10. For example, the manipulation button 75 may be a reset switch. For another example, the manipulation button 75 may be a power switch to turn on/off the display 70.

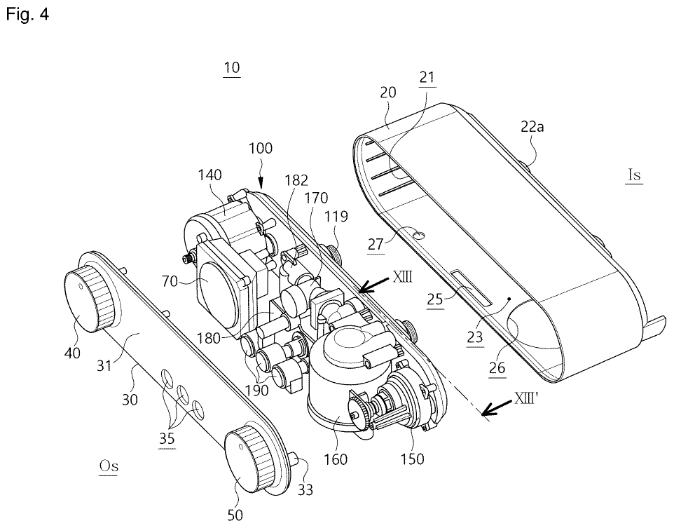

FIG. 4 illustrates disassembled parts constituting the water supply device 10. As is illustrated, the exterior and frame of the water supply device 10 may be formed by a casing 20. The casing 20 may be provided with an installation space 23 inside. The front of the installation space 23 is open, and the open portion 21 of casing 20 may be covered by a cover plate 30. In this embodiment, the casing 20 may be formed to be longer in a left and right width than in height. The upper and lower surfaces of the casing 20 may have planar structures parallel to each other. The left and right surfaces of the casing 20 may be curved surfaces. This form of the casing 20 is just one example, and the casing 20 may have various forms. The casing 20 may be regarded as a faucet body.

A rear surface cover 22 may be provided on the rear surface of the casing 20. The rear surface cover 22 may shield the rear of the installation space 23. The rear surface cover 22 may have a structure that protrudes rearward from the casing 20. The rear surface cover 22 may be integrally provided on the rear of the casing 20. The rear surface cover 22 may include an inflow guide 22a for connection to the inlets IH. The inflow guide 22a may be configured as one pair of inflow guides for the inflow of hot water and cold water. Reference numeral 22b indicates a hose passage hole through which a hose passes when the hose is extended.

The lower water outlet 25 may be provided on a lower portion of the installation space 23. The lower water outlet 25 may be connected to the third outlet OH3. Water discharged through the third outlet OH3 may fall downward through the lower water outlet 25. The lower water outlet 25 may be in the form of a long hole in the left-to-right direction.

A filter hole 26 may be open in a lower portion of the installation space 23. The filter hole 26 may be made through the lower surface of the casing 20. The filter hole 26 may be considered as a hole through which the filter part 163 to be described below enters and exits. The filter hole 26 may be made circular in a lower right portion of the installation space 23. The shape of the filter hole 26 may be of various shapes corresponding to the shape of the filter part 163. Reference numeral 27 denotes a hole through which the operation button 75 protrudes.

As illustrated in FIG. 4, the display 70, the flow path guide pack 100, the thermostat 140, the flow rate controller 150, the filter 160, the generator 170, and the water discharge selector 180 may be arranged inside the installation space 23. Among the display 70, the flow path guide pack 100, the thermostat 140, the flow rate controller 150, the filter 160, the generator 170 and the water discharge selector 180, the display 70, the flow path guide pack 100, and the generator 170 may not be exposed to the outside but be stored in the installation space 23. Parts of the thermostat 140, the flow rate controller 150, the filter 160, and the water discharge selector 180 may be exposed to the outside to be manipulated or replaced.

The display 70 may provide various information to a user by using power generated by the generator 170. The display 70 may include the control device. The display 70 may display information such as the temperature and flow rate of the water being discharged, the period of use of the filter part 163, the replacement time of the filter 160, and a currently selected water discharge part. The cover plate 30 may be disposed in front of the display 70, but the cover plate 30 may transmit light emitted of the display 70 forward. To this end, all or part of the cover plate 30 may be made of a transparent or translucent material. When the display 70 is configured as a touch panel, a user may input an operation command by touching the surface of the cover plate 30.

Although not shown, the control device may include a communication module for communication. The communication module may include one or more of a Bluetooth communication module, a WiFi communication module, a Zigbee communication module, and an NFC communication module. The communication modules may receive power through the generator 170.

The thermostat 140, the flow rate controller 150, the filter 160, the generator 170, and the water discharge selector 180 may each be connected to the flow path guide pack 100. Here, the connection may mean that water can pass between two parts. In this embodiment, except for the generator 170 and the water discharge selector 180, each component is not directly connected to each other, but may be indirectly connected through the flow path guide pack 100. Accordingly, the flow path guide pack 100 may provide flow paths for the flow of water. The flow path guide pack 100 may provide flow paths of sufficiently wide and predetermined sizes inside. This structure will be explained in detail again below. This structure will be described in detail again below.

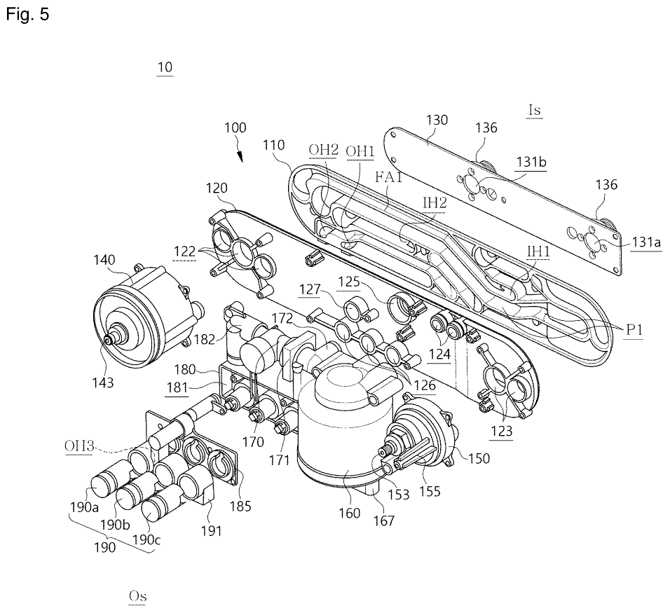

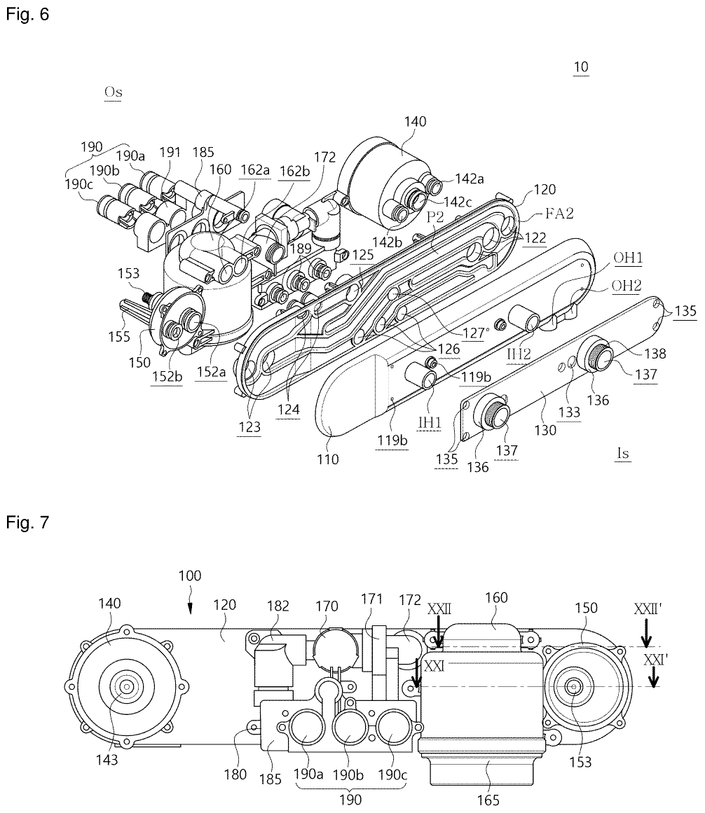

FIGS. 5 and 6 illustrate the exploded states of components arranged in the installation space 23. FIG. 5 illustrates components viewed from a side in front of the water supply device 10, and FIG. 6 illustrates the components viewed from a side behind the water supply device 10. As illustrated in the drawings, the flow path guide pack 100 and the reinforcing plate 130 may be placed at a rearmost position. The thermostat 140, the flow rate controller 150, the filter 160, the generator 170, and the water discharge selector 180 may be arranged on the front of the flow path guide pack 100.

In this embodiment, the thermostat 140, the flow rate controller 150, the filter 160, the generator 170, and the water discharge selector 180 may be arranged left and right or up and down. More precisely, the generator 170 and the water discharge selector 180 may be arranged in a vertical direction at different heights. The thermostat 140 and the flow rate controller 150 may be arranged to be spaced apart from each other in the left-to-right direction. The filter 160, the generator 170, and the water discharge selector 180 may be disposed between the thermostat 140 and the flow rate controller 150. In this way, when the parts except for the flow path guide pack 100 are not arranged in the front-to-rear direction, but are arranged left and right or up and down, the front-to-rear length of the water supply device 10 may be minimized. As described above, when the front-to-rear length of the water supply device 10 is short, torque applied to the installation adapters 7a and 7b may be reduced.

The flow path guide pack 100 may be provided with a plurality of flow paths P inside. The plurality of flow paths P may transmit water to or receive water from the thermostat 140, the flow rate controller 150, the filter 160, the generator 170, and the water discharge selector 180. The flow path guide pack 100 may be considered as being dedicated to the flow paths of water. Of course, water may flow inside the thermostat 140, the flow rate controller 150, the filter 160, the generator 170, and the water discharge selector 180, but the role of transmitting water between the parts may be performed by the flow path guide pack 100.

Inside the installation space 23, the flow path guide pack 100 may be disposed at a position that is biased toward the rear surface cover 22 rather than the cover plate 30. The flow path guide pack 100 may be arranged at a position farther from the cover plate 30 than the thermostat 140, the flow rate controller 150, the filter 160, the generator 170, and the water discharge selector 180. The flow path guide pack 100 may have a larger area than other parts, and be heavy due to the addition of the weight of water flowing through the flow paths P inside. When the flow path guide pack 100 is arranged close to the installation surface W, torque applied to the installation adapters 7a and 7b by the weight of the flow path guide pack 100 may be reduced.

In this embodiment, the flow path guide pack 100 may be disposed closer to the installation surface W than the thermostat 140, the flow rate controller 150, the filter 160, the generator 170, and the water discharge selector 180. The installation adapters 7a and 7b, which transmit external water, may be installed on the installation surface W. When the flow path guide pack 100 is arranged close to the installation surface W, a path through which external water flows into the flow path guide pack 100 may be short.

The flow path guide pack 100 may be erected at the rear of the installation space 23. Here, the being erected means that the opposite ends of the flow path guide pack 100 having a width greater than the thickness of the flow path guide pack 100 based on the coupling direction of the first flow path body 110 and the second flow path body 120 constituting the flow path guide pack 100 are arranged in a vertical direction. In other words, it may be considered that opposite ends having longest sections among edges of a coupling surfaces on which the first flow path body 110 and the second flow path body 120 are coupled to each other are arranged in the vertical direction.

In another embodiment, the flow path guide pack 100 may be arranged in the upper or lower portion of the installation space 23. That is, the flow path guide pack 100 may be arranged in a horizontal direction in the upper portion of the installation space 23, or may be arranged in the horizontal direction in the lower portion of the installation space 23.

Referring to FIG. 7, the flow path guide pack 100 may be erected at the rearmost position. Each of the thermostat 140, the flow rate controller 150, the filter 160, the generator 170, and the water discharge selector 180 may be arranged in whole or in part to overlap the front surface of the flow path guide pack 100 in the front-to-rear direction. Accordingly, the thermostat 140, the flow rate controller 150, the filter 160, the generator 170, and the water discharge selector 180 may be connected to the flow path guide pack 100 in portions overlapping the flow path guide pack 100.

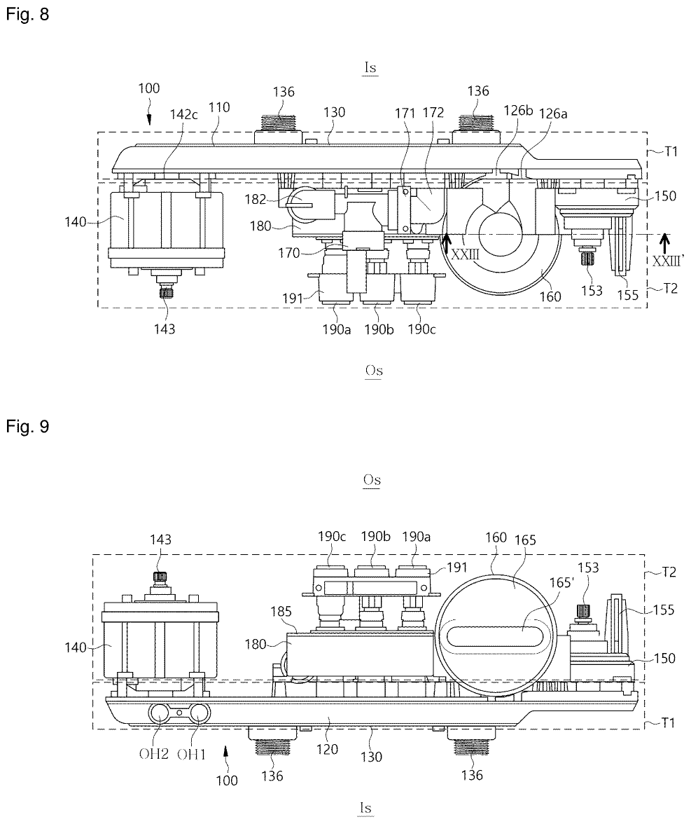

Referring to FIGS. 8 and 9, the flow path guide pack 100 may be arranged in a first area T1 of the installation space 23. The thermostat 140, the flow rate controller 150, the filter 160, the generator 170, and the water discharge selector 180 may be arranged in a second area T2 of the installation space 23. The first area T1 and the second area T2 are formed by arbitrarily dividing the installation space 23. Here, the second area T2 may be located closer to the front surface of the casing 20 than the first area T1. Conversely, the first area T1 may be provided closer to the installation surface W than the second area T2. The flow path guide pack 100 may be arranged in the first area T1 without going into the second area T2. Through this, the installation space 23 may be utilized efficiently.

Referring to FIGS. 5 and 6, the flow path guide pack 100 may include the first flow path body 110 and the second flow path body 120. The first flow path body 110 and the second flow path body 120 may have shapes that correspond to each other. When the first flow path body 110 and the second flow path body 120 are combined with each other, the first flow path body 110 and the second flow path body 120 may have the same areas so that any one of the first flow path body 110 and the second flow path body 120 does not protrude further outside the perimeter thereof. When the first flow path body 110 and the second flow path body 120 are combined with each other, the plurality of flow paths P may be formed therebetween.

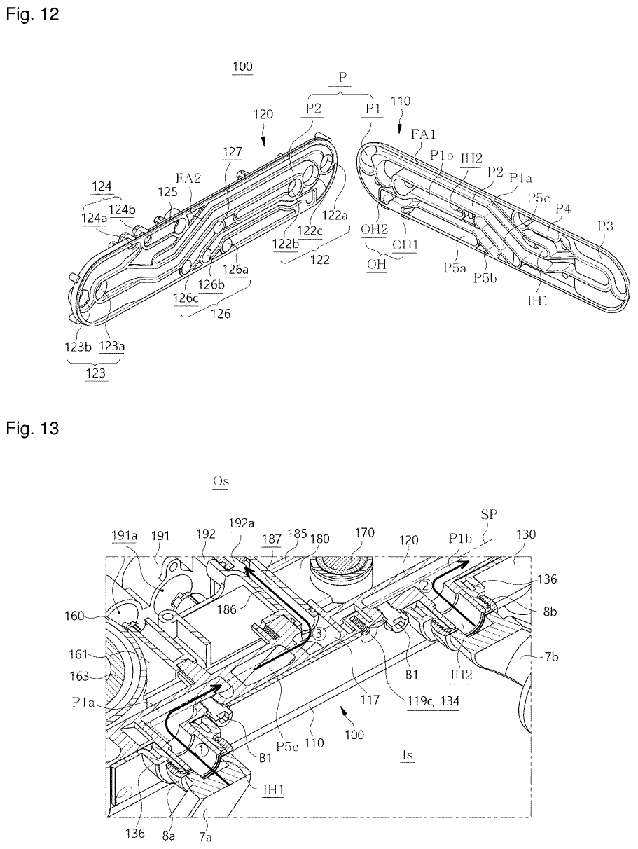

Referring to FIG. 5, in the first flow path body 110, first paths P1 may be provided in recessed forms. Referring to FIG. 6, in the second flow path body 120, second paths P2 may be provided in recessed forms. Each of the first paths P1 and each of the second paths P2 may have shapes and positions corresponding to each other. Referring to FIG. 12, the first paths P1 and the second paths P2 may make the flow paths P which are continuous in the front-to-rear direction.

The flow paths P may form paths independent of the installation space 23. Since the flow paths P are provided inside the flow path guide pack 100, the flow paths P may be separated from the installation space 23 to form independent paths.

The plurality of flow paths P may be composed of individual flow paths P1 to P5 that are independent of each other. The individual flow paths P1 to P5 may (i) transmit water introduced through the inlet IH to each of parts, (ii) connect the parts to each other, and (iii) discharge water passing through the parts through an outlet OH. The individual flow paths P may have independent paths. Here, independence may mean that each of the individual flow paths P1 to P5 has a separated path without being connected to each other.

The first flow path body 110 and the second flow path body 120 may be respectively provided with a first close contact part FA1 and a second close contact part FA2 corresponding to each other. The first close contact part FA1 may protrude from the surface of the first flow path body 110 in a direction toward the second flow path body 120. Conversely, the second close contact part FA2 may protrude from the surface of the second flow path body 120 in a direction toward the first flow path body 110. The first close contact part FA1 and the second close contact part FA2 may be in close contact with each other to form the flow paths P. When the first close contact part FA1 and the second close contact part FA2 are in close contact with each other, the first close contact part FA1 and the second close contact part FA2 may be a kind of walls continuous in front-to-rear directions, and the flow paths P may be formed between the walls.

In a portion in which the first flow path body 110 and the second flow path body 120 face each other, the flow paths P may be formed in the remaining portion except for portions on which the first close contact part FA1 and the second close contact part FA2 are in close contact with each other. That is, since the first close contact part FA1 and the second close contact part FA2 are a kind of walls continuous in the front-to-rear directions, the flow paths P, which are empty spaces, may be formed in the remaining portions except for a portion on which the first close contact part FA1 and the second close contact part FA2 are in close contact with each other.

The first close contact part FA1 and the second close contact part FA2 may be fused to each other. Here, “fusion” means “being fixed to each other” in close contact with each other. The first close contact part FA1 and the second close contact part FA2 may be fused to each other by using vibration fusion, heat fusion, or ultrasonic fusion. The heat fusion may be implemented in a method in which after heating, softening, and melting the first flow path body 110 and the second flow path body 120 fixed to two jigs by pressing the first flow path body 110 and the second flow path body 120 with a hot plate heated to a temperature slightly higher than the melting temperature of the material of the first flow path body 110 and the second flow path body 120, when fusing areas are sufficiently melted, the hot plate is removed, the first flow path body 110 and the second flow path body 120 are pressed to each other, and then are cooled until hardens to fuse the first flow path body 110 and the second flow path body 120.

For another example, the first close contact part FA1 and the second close contact part FA2 may be coupled to each other by bonding. For still another example, the first flow path body 110 and the second flow path body 120 may be coupled to each other by using separate fasteners such as screws. In this case, the first close contact part FA1 and the second close contact part FA2 may be sealed by using a rubber sealing member.

Prior to describing the detailed structure of the flow paths P, to describe the reinforcing plate 130, the reinforcing plate 130 may reinforce the strength of the flow path guide pack 100. The flow path guide pack 100 may be connected to the installation adapters 7a and 7b, so that torque due to the weight of the water supply device 10 along with the installation adapters 7a and 7b may be concentrated on the flow path guide pack 100. Accordingly, the flow path guide pack 100 may be damaged or removed from an installation position thereof. The reinforcing plate 130 may prevent the damage or removal of the flow path guide pack 100.

Specifically, the reinforcing plate 130 may have a flat plate structure. The reinforcing plate 130 may be made of a high-strength metal material. The reinforcing plate 130 may be in surface contact with the surface of the flow path guide pack 100. The reinforcing plate 130 may be coupled to the first flow path body 110 in surface contact with the surface of the first flow path body 110 of the flow path guide pack 100. The installation adapters 7a and 7b may be coupled to the reinforcing plate 130. Accordingly, the installation adapters 7a and 7b may not be directly coupled to the flow path guide pack 100, but may be indirectly coupled thereto through the reinforcing plate 130.

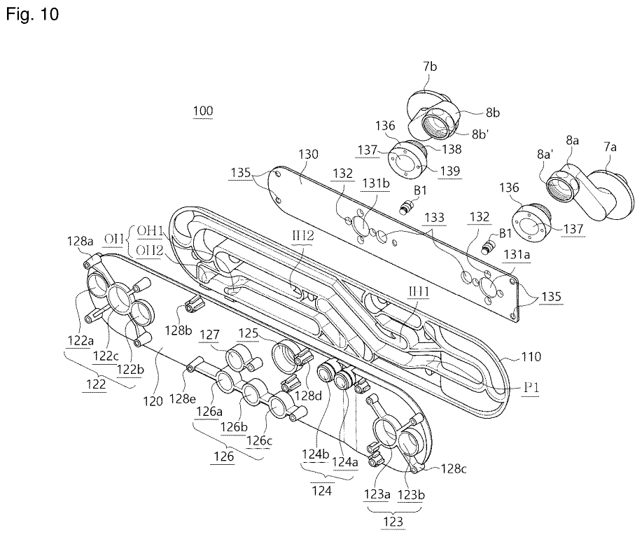

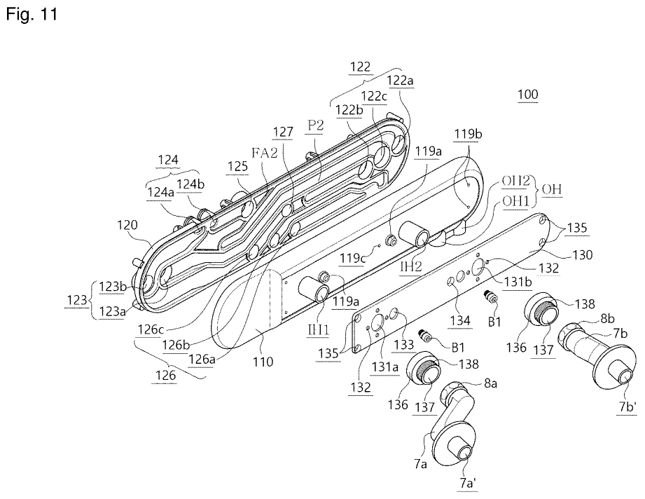

Referring to FIGS. 10 and 11, in the reinforcing plate 130, one pair of plate holes 131a and 131b may be open. Among the one pair of plate holes 131a and 131b, a first plate hole 131a may be a part through which cold water is introduced. Among the one pair of plate holes 131a and 131b, a second plate hole 131b may be a part through which hot water is introduced. The first plate hole 131a may be connected to a first adapter 7a among the installation adapters 7a and 7b, and the second plate hole 131b may be connected to a second adapter 7b among the installation adapters 7a and 7b.

Flange fastening holes 132 may be provided around the plate hole 131a or 131b. The flange fastening holes 132 are fastening holes for the coupling of the flange 136. After fasteners (not shown) pass through the flange fastening holes 132 and are fastened to fastening grooves 139 of the flange 136, the flange 136 may be fixed to the reinforcing plate 130. The flange 136 is intended to be assembled with the installation adapters 7a and 7b, and a flange thread 138 may be provided on the surface of the flange 136.

Service holes 133 may be open in the reinforcing plate 130. The service holes 133 are intended for maintenance of the water supply device 10. The service holes 133 may be connected to through holes 119a of the first flow path body 110. When a service stopper B1 is fastened to each of the through holes 119a of the first flow path body 110 after the service stopper B1 passes through each of the service holes 133, the service hole 133 and the through hole 119a may be maintained to be normally blocked. When the service stopper B1 is removed and washing water or high temperature steam is injected into the flow path guide pack 100 through the service hole 133, the flow paths P and each component inside the flow path guide pack 100 may be washed.

Body fastening holes 135 may be open in the reinforcing plate 130. The body fastening holes 135 are intended to combine the reinforcing plate 130 and the first flow path body 110 with each other. A fastener (not shown) passing through each of the body fastening holes 135 may be assembled to the fixing hole 119b of the first flow path body 110. Accordingly, the reinforcing plate 130 may be coupled to the first flow path body 110. The body fastening holes 135 may be arranged on the edge of the reinforcing plate 130.

In this embodiment, while the reinforcing plate 130 is coupled to the flow path guide pack 100, the reinforcing plate 130, together with the flow path guide pack 100, may be stored in the installation space 23. In this case, the flange 136 of the reinforcing plate 130 may be exposed rearward through the inflow guide 22a of the rear surface cover 22. The nut parts 8a and 8b of the installation adapters 7a and 7b may be assembled on the flange 136. In this case, raw water may be supplied into the flow path guide pack 100 through adapter inlets 7a′ and 7b′ of the installation adapters 7a and 7b.

For reference, the adapter inlets 7a′ and 7b′ of the installation adapters 7a and 7b may be connected to a raw water supply pipe (not shown) fixed to the installation surface W. Briefly looking at the installation adapters 7a and 7b with reference to FIG. 11, the installation adapters 7a and 7b may be configured as one pair of installation adapters. Cold water may be supplied through the first adapter 7a of the installation adapters 7a and 7b. Hot water may be supplied through the second adapter 7b of the installation adapters 7a and 7b. In the first adapter 7a, a first adapter inlet 7a′ may be open, and in the second adapter 7b, a second adapter inlet 7b′ may be open.

Reference numeral 8a is a first nut part 8a provided in the first adapter 7a, and reference numeral 8b is a second nut part provided in the second adapter 7b. In this embodiment, the first adapter inlet 7a′ and the first nut part 8a may have a structure eccentric to each other rather than being coaxial with each other. Even if there is an error in a gap between one pair of raw water supply pipes mounted in the installation surface W, the eccentric structure may allow the error to be compensated. Reference numerals 8a′ and 8b′ indicate adapter holes connected to the adapter inlets 7a′ and 7b′, respectively. Each of the adapter holes 8a′ and 8b′ may be connected to a flange hole 137 formed through the flange 136.

Referring to FIG. 10, when looking at the first flow path body 110 constituting the flow path guide pack 100, the inlets IH may be provided in the first flow path body 110. The inlet IH may be a part for supplying external raw water into the flow paths P. Cold and hot water may be supplied through the inlet IH. In this embodiment, the inlet IH may include a first inlet IH for cold water inflow and a second inlet IH for hot water inflow. As another example, only one inlet IH may be provided in the first flow path body 110.

The inlet IH may be open in the front-to-rear direction in the first flow path body 110. More specifically, the first flow path body 110 and the second flow path body 120 may be coupled to each other in the first direction (the front-to-rear direction), and the inlet IH may also be open in the first direction. In this case, the inlet IH may be provided by penetrating a wide portion of the first flow path body 110, and the diameter of the inlet IH may be increased. When the diameter of the inlet IH increases, external raw water may be introduced efficiently through the inlet IH. When the diameter of the inlet IH is small, water pressure in the inlet IH may increase, and cracks and water leaks may occur in a fused portion between the first flow path body 110 and the second flow path body 120. In this embodiment, the inlet IH may also be open in the first direction to reduce the water pressure.

The first flow path body 110 may include an outlet OH. The outlet OH may be a part through which water passing through the flow path guide pack 100 is discharged to the outside. Here, the outside refers to space to which water is discharged through the outlet. A separate hose may be coupled to the outlet OH, allowing water to be discharged at a distant location.

In this embodiment, the outlet OH may include the first outlet OH1, the second outlet OH2, and the third outlet OH3. The first outlet OH1 and the second outlet OH2 may be arranged to be adjacent to each other, but in another example, the first outlet OH1 and the second outlet OH2 may be spaced apart from each other.

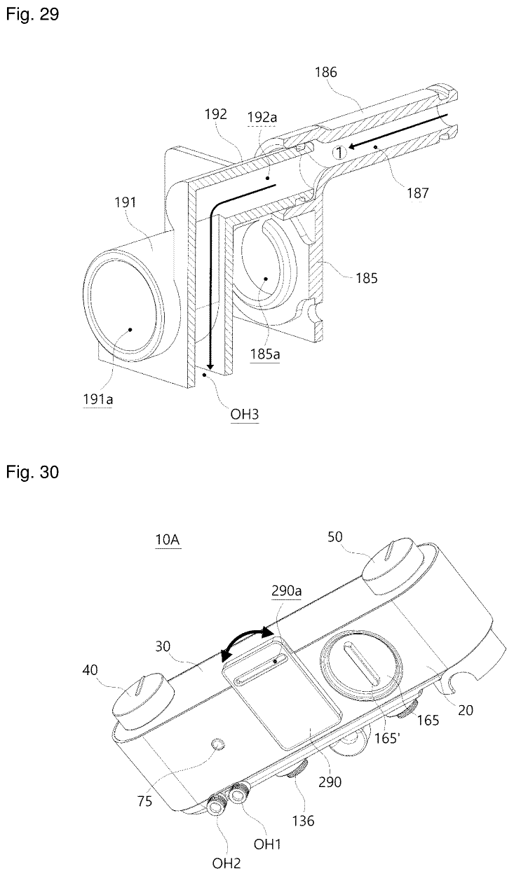

As illustrated in FIG. 10, the first outlet OH1 and the second outlet OH2 may be disposed in the first flow path body 110. On the other hand, the third outlet OH3 may be arranged not in the first flow path body 110 but in the water discharge selector 180. Referring to FIG. 29, a movement guide 191 constituting the water discharge selector 180 may include a guide water discharge pipe 192 whose first end part is inserted into the flow path guide pack 100, and the third outlet OH3 may be provided on an end of the guide water discharge pipe 192. For another example, the guide water discharge pipe 192 of the movement guide 191 may be omitted, and the third outlet OH3 may be provided in the flow path guide pack 100.

Referring to FIG. 11, the first flow path body 110 may be provided with the through hole 119a. The service stopper B1 may be coupled to the through hole 119a. Each of fixing holes 119b to which the fastener is fastened may be disposed on the edge of the first flow path body 110. Reference numeral 119c denotes an additional fixing hole corresponding to the additional fastening hole of the reinforcing plate 130. A separate fastener (not shown) may be fastened to the additional fixing hole 119c, so that a fastening force between the reinforcing plate 130 and the first flow path body 110 may be increased.

Referring to FIG. 12, the first flow path body 110 may include a plurality of flow paths P. The plurality of flow paths P may each perform different functions. The plurality of flow paths P may extend in left-to-right directions. The plurality of flow paths P may extend in inclined directions in some sections. The specific function of each of the flow paths P will be described again below.

The plurality of flow paths P may be arranged on the same plane inside the flow path guide pack 100. In FIG. 13, reference numeral SP indicates a plane crossing the inside of the flow path guide pack 100. Here, the same plane refers to a virtual plane and may refer to a plane made by a Y-axis and a Z-axis in FIG. 1.

Referring to FIG. 13, among the plurality of flow paths P, a first inflow path P1a connecting the first inlet IH with the thermostat 140, and a second inflow path P1b connecting the second inlet IH with the thermostat 140 are illustrated. In addition, in FIG. 13, a third outflow path P5c connecting the filter 160 with the third outlet OH3 is illustrated. The first inflow path Pa, the second inflow path P1b, and the third outflow path P5c may be provided on the same plane. Although not shown in FIG. 13, a mixed water flow path P2, a filter flow path P3, a transmission flow path P4, a first outflow path P5a, and a second outflow path P5b, which will be described below, may all be provided on the same plane. Accordingly, when the flow paths P are arranged on the same plane, a front-to-rear width occupied by the flow paths may be maintained constant, so the flow path guide pack 100 may be miniaturized. Additionally, when the flow paths P are arranged on the same plane, a portion excessively bent in the flow paths may be removed, thereby facilitating the flow of water.

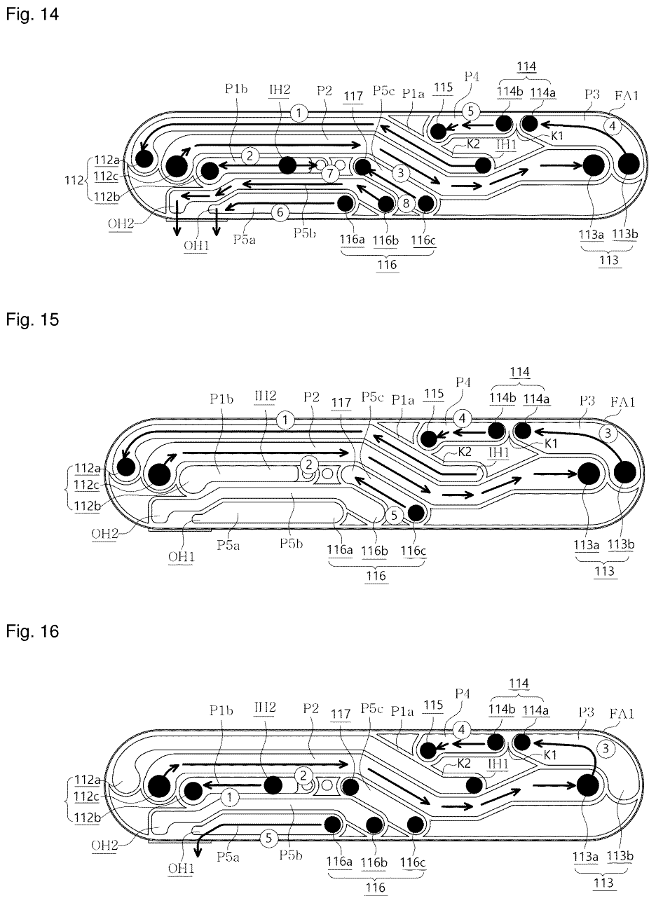

FIG. 14 illustrates the direction of water flow inside the flow path guide pack 100 with an arrow. For reference, FIG. 14 illustrates the discharge of mixed water mixed with cold water and hot water. As illustrated, cold water introduced into the first inlet IH may move along the first inflow path P1a (the direction of arrow \textcircled{1}). A first end part of the first inflow path Pa may be connected to the first inlet IH, and a second end part thereof may be connected to a first inlet pipe 142a of the thermostat 140. Reference numeral 112a denotes a first inlet point 112a connected to the first inlet pipe 142a.

Meanwhile, hot water introduced into the second inlet IH may move along the second inflow path P1b (the direction of arrow \textcircled{2}). A first end part of the second inflow path P1b may be connected to the second inlet IH, and a second end part thereof may be connected to a second inlet pipe 142b of the thermostat 140. Reference numeral 112b denotes a second inlet point 112b connected to the second inlet pipe 142b.

Cold water and hot water flowing into the thermostat 140 through the first inlet pipe 142a and the second inlet pipe 142b, respectively, may be mixed inside the thermostat 140. The thermostat 140 may mix incoming cold water and hot water with each other to control the temperature of the mixed water. In this case, the thermostat 140 may be regarded as a type of valve. In this embodiment, the thermostat 140 may implement the constant temperature function of maintaining the temperature of the mixed water around a set temperature. The thermostat 140 may control the ratio of cold and hot water mixed by adjusting the degree of the opening of the valve that opens and closes inside.

Reference numeral 112c denotes a mixed water discharge point 112c. The mixed water discharge point 112c may be connected to the discharge pipe 142c of the thermostat 140. Mixed water discharged through the discharge pipe 142c of the thermostat 140 may flow along the mixed water flow path P2, which starts at the mixed water discharge point 112c and ends at a flow rate control point 113a (the direction of arrow \textcircled{3}). The mixed water flow path P2 may be arranged between the first inflow path P1a and the second inflow path P1b. More precisely, some sections of the mixed water flow path P2 may be placed under the first inflow path P1a and above the second inflow path P1b.

The mixed water that reaches the flow rate control point 113a may flow into the flow rate controller 150. The flow rate controller 150 may be provided with a control inlet 152a (see FIG. 6) and a control outlet 152b. The control inlet 152a may be connected to the flow rate control point 113a. The control outlet 152b may be a portion through which water is discharged at a flow rate controlled through the flow rate controller 150. The control outlet 152b may be connected to a controlled water discharge point 113b of the flow path guide pack 100.

The filter flow path P3 may connect the controlled water discharge point 113b with a filter introduction point 114a. Through the filter flow path P3, control water may be provided to a filter inlet 162a (see FIG. 6) of the filter 160 (the direction of arrow \textcircled{4}). The controlled water that has passed through the filter 160 may be purified water. The purified water may be discharged through a filter outlet 162b of the filter 160. Reference numeral 114b denotes a filter discharge point 114b connected to the filter outlet 162b.

The transmission flow path P4 may be provided between the filter discharge point 114b and a power supply point 115. The transmission flow path P4 may be a flow path for transmitting the purified water to the generator 170. The purified water may be supplied to the generator 170 through the transmission flow path P4 (the direction of arrow \textcircled{5}).

In this embodiment, the power supply point 115 may not be connected to other points, and the flow path may be cut off at the power supply point 115. The power supply point 115 may be connected to a power generation inlet 172 (see FIG. 5) of the generator 170, so that purified water may be supplied to the generator 170. The purified water may be transmitted through the power generation inlet 172 to the generator 170 (the direction of arrow \textcircled{5}). The generator 170 may be operated through the pressure of the purified water.

Purified water that has passed through the generator 170 may be transmitted to the water discharge selector 180. Reference numeral 116 indicates a selection point 116 to which purified water discharged through the water discharge selector 180 is discharged. The selection point 116 may include a first selection point 116a, a second selection point 116b, and a third selection point 116c. The first selection point 116a may be connected to the first outlet OH1 through the first outflow path P5a. The purified water may be discharged to the first outlet OH1 through the first outflow path P5a. The second selection point 116b may be connected to the second outlet OH2 through the second outflow path P5b. The purified water may be discharged to the second outlet OH2 through the second outflow path P5b.

Finally, the third selection point 116c may be connected to the guide water discharge pipe 192 (see FIG. 29) through the third outflow path P5c. The purified water may be discharged to the third outlet OH3 through the third outflow path P5c. More precisely, the purified water may move to a water discharge point 117 through the third outflow path P5c (the direction of arrow \textcircled{8}). In addition, referring to FIG. 13, the purified water may move forward through a selector water discharge pipe 186 and the guide water discharge pipe 192 connected to the water discharge point 117 (the direction of arrow \textcircled{3}) in FIG. 13). The purified water moved forward may be discharged through the third outlet OH3 provided at the end of the guide water discharge pipe 192 (see an arrow in FIG. 29).

Accordingly, in the flow path guide pack 100, raw water may be introduced through the inlet IH, and then may flow to components through the flow paths P inside. Water (purified water) that has passed through the above components after passing through the inlet IH may be finally discharged through the outlet OH to the outside. Since the flow paths P are made integrally inside the flow path guide pack 100, the flow paths P inside the flow path guide pack 100 may have a large cross-sectional area compared to the volume of the flow path guide pack 100. Since the flow path guide pack 100 is dedicated to the transmission of water, efficient water flow is possible through the large volume of the flow paths P.

FIG. 15 illustrates a process in which external cold water is introduced and discharged through the third outlet OH3 without mixing with hot water. As illustrated, cold water flowing into the first inlet IH may move along the first inflow path P1a (the direction of arrow \textcircled{1}). Cold water introduced into the thermostat 140 through the first inlet pipe 142a may flow into the inside of the thermostat 140. The thermostat 140 may discharge the introduced cold water without mixing the introduced cold water with hot water.

Cold water discharged through the discharge pipe 142c of the thermostat 140 may flow along the mixed water flow path P2, which starts at the mixed water discharge point 112c and ends at the flow rate control point 113a (the direction of arrow \textcircled{2}). Mixed water (cold water) that has reached the flow rate control point 113a may flow into the flow rate controller 150. Cold water introduced into the inside of the flow rate controller 150 through the control inlet 152a of the flow rate controller 150 may be discharged through the control outlet 152b of the flow rate controller 150 after the discharge flow rate of the cold water is controlled.

The controlled water discharged to the control outlet 152b may be provided to the filter inlet 162a of the filter 160 through the filter flow path P3 (the direction of arrow \textcircled{3}). The controlled water that has passed through the filter 160 may become purified water. The purified water may be discharged through the filter outlet 162b of the filter 160. The purified water may be supplied to the generator 170 through the transmission flow path P4 (the direction of arrow \textcircled{4}).

Purified water that has passed through the generator 170 may be transmitted to the water discharge selector 180. In FIG. 15, a third selection flow path may be selected in the water discharge selector 180, and the purified water may be discharged to the third outlet OH3 through the third outflow path P5c (the direction of arrow \textcircled{5}).

Meanwhile, FIG. 16 illustrates a process in which external hot water is introduced and discharged through the second outlet OH2 without mixing with cold water. As illustrated, hot water flowing into the second inlet IH may move along the second inflow path P1b (the direction of arrow \textcircled{1}). Hot water introduced to the thermostat 140 through the second inlet pipe 142b may flow into the inside of the thermostat 140. The thermostat 140 may discharge the introduced hot water without mixing the introduced hot water with cold water.

The hot water discharged through the discharge pipe 142c of the thermostat 140 may flow along the mixed water flow path P2, which starts at the mixed water discharge point 112c and ends at the flow rate control point 113a (the direction of arrow \textcircled{2}). Mixed water (hot water) that reaches the flow rate control point 113a may flow into the flow rate controller 150. The hot water flowing into the interior of the flow rate controller 150 through the control inlet 152a of the flow rate controller 150 may be discharged through the control outlet 152b of the flow rate controller 150 after the discharge flow rate of the hot water is controlled.

The controlled water discharged to the control outlet 152b may be provided to the filter inlet 162a of the filter 160 through the filter flow path P3 (the direction of arrow \textcircled{3}). The controlled water that has passed through the filter 160 may be purified water. The purified water may be discharged through the filter outlet 162b of the filter 160. The purified water may be supplied to the generator 170 through the transmission flow path P4 (the direction of arrow \textcircled{4}).

Purified water that has passed through the generator 170 may be transmitted to the water discharge selector 180. In FIG. 16, a second selection flow path may be selected in the water discharge selector 180, and the purified water may be discharged to the second outlet OH2 through the second outflow path P5b (the direction of arrow \textcircled{5}).

Meanwhile, looking at the second flow path body 120, the second flow path body 120, like the first flow path body 110, may be made into a flat plate structure. Referring to FIGS. 11 and 12, the second path corresponding to the first path of the first flow path body 110 may be formed in a recessed form in the second flow path body 120. The second path may be connected to the first path to form one path.

The second flow path body 120 may be provided with a plurality of connectors 122, 123, 124, 125, 126, and 127. The connectors 122, 123, 124, 125, 126, and 127 are intended to connect the flow paths P with components disposed on the outside of the flow path guide pack 100. Some of the connectors 122, 123, 124, 125, 126, and 127 may constitute a portion through which water is discharged from the flow path guide pack 100. Accordingly, some of the connectors 122, 123, 124, 125, 126, and 127 may be considered to constitute an outlet.

The connectors 122, 123, 124, 125, 126, and 127 may be formed in the second flow path body 120 in a rear-to-front direction (an X-axis direction in FIG. 1), which is a coupling direction of the second flow path body 120 and the first flow path body 110. Accordingly, when the connectors 122, 123, 124, 125, 126, and 127 are open in the first direction in which the first flow path body 110 and the second flow path body 120 are combined with each other, the connectors 122, 123,124, 125, 126, and 127 may be arranged at various locations by using the wide surface of the second flow path body 120. In addition, when the connectors 122, 123, 124, 125, 126, and 127 are open in the first direction in which the first flow path body 110 and the second flow path body 120 are coupled to each other, components such as the generator 170 and the filter 160 may be arranged side by side on the front of the flow path guide pack 100.

The connector may include a temperature control connector 122 connected to the thermostat 140. The temperature control connector 122 may be connected to each of the first inlet pipe 142a, the second inlet pipe 142b, and the discharge pipe 142c of the thermostat 140. To this end, the temperature control connector 122 may include a first temperature control connector 122a, a second temperature control connector 122b, and a third temperature control connector 122c. The first temperature control connector 122a may be provided at a position corresponding to the first inlet point 112a of the first flow path body 110. The second temperature control connector 122b may be provided at a position corresponding to the second inlet point 112b. The third temperature control connector 122c may be provided at a position corresponding to the mixed water discharge point 112c.

The connector may include a flow-rate control connector 123 connected to the flow rate controller 150. The flow-rate control connector 123 may be arranged on the opposite side of the temperature control connector 122. The flow-rate control connector 123 may be connected to each of the control inlet 152a and the control outlet 152b of the flow rate controller 150. To this end, the flow-rate control connector 123 may include a first flow-rate control connector 123a and a second flow-rate control connector 123b. The first flow-rate control connector 123a may be provided at a position corresponding to the flow rate control point 113a of the first flow path body 110. The second flow-rate control connector 123b may be provided at a position corresponding to the controlled water discharge point 113b.

The connector may include a filter connector 124 connected to the filter 160. The filter connector 124 may be connected to each of the filter inlet 162a and the filter outlet 162b of the filter 160. To this end, the filter connector 124 may include a first filter connector 124a and a second filter connector 124b. The first filter connector 124a may be provided at a position corresponding to the filter introduction point 114a of the first flow path body 110. The second filter connector 124b may be provided at a position corresponding to the filter discharge point 114b.

The connector may include a generator connector 125 connected to the generator 170. The generator connector 125 may be connected to the power generation inlet 172 of the generator 170. The generator connector 125 may be provided at a position corresponding to the power supply point 115 of the first flow path body 110.

The connector may include a selector connector 126 connected to the water discharge selector 180. The selector connector 126 may be connected to each of a plurality of selector outlets 189 provided in the water discharge selector 180. To this end, the selector connector 126 may include a first selector connector 126a, a second selector connector 126b, and a third selector connector 126c. The first selector connector 126a may be provided at a position corresponding to a first selector outlet 189a of the water discharge selector 180. The second selector connector 126b may be provided at a position corresponding to a second selector outlet 189b of the water discharge selector 180. The third selector connector 126c may be provided at a position corresponding to a third selector outlet 189c of the water discharge selector 180.

The connector may include a water discharge connector 127 connected to the selector water discharge pipe 186 of the water discharge selector 180. The water discharge connector 127 may discharge purified water in a direction toward the third outlet OH3 through the selector water discharge pipe 186. The water discharge connector 127 may be connected to the water discharge point 117 of the first flow path body 110.

Referring to FIG. 10, the second flow path body 120 may be provided with fixing parts for fixing the parts. The fixing parts may protrude forward from the surface of the second flow path body 120 toward the front, that is, toward the cover plate 30. Fasteners (not shown) such as screws may be fastened to the fixing parts to fix components. Reference numeral 128a denotes a first fixing part for fixing the thermostat 140. Reference numeral 128b denotes a second fixing part for fixing the generator 170. Reference numeral 128c denotes a third fixing part for fixing the flow rate controller 150. Reference numeral 128d denotes a fourth fixing part for fixing the filter 160. Reference numeral 128e denotes a fifth fixing part for fixing the water discharge selector 180.

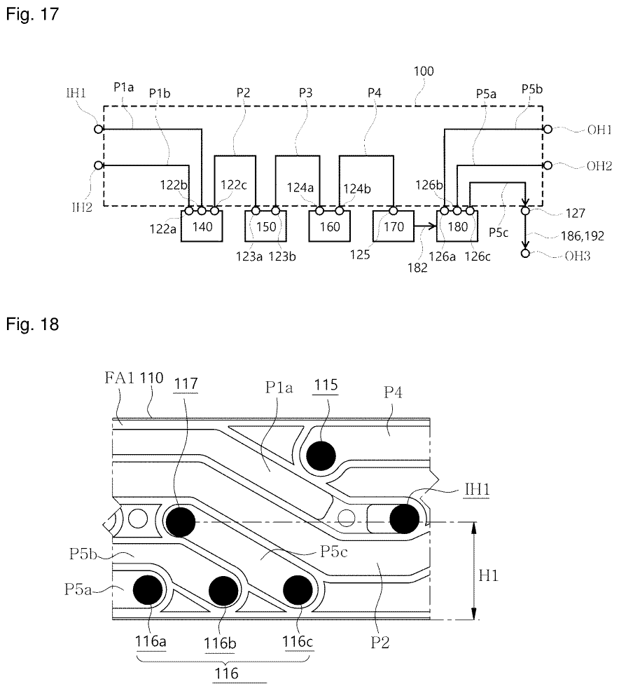

Referring to FIG. 17, the connection structure of the flow paths P of the flow path guide pack 100, the connectors 122, 123, 124, 125, 126, and 127 of the flow path guide pack 100, and other components is illustrated in a block diagram. As illustrated, the flow path guide pack 100 may be responsible for the inflow of raw water through the inlet IH, the discharge of purified water through the outlet OH, and connection between components. The flow path guide pack 100 may connect the remaining components to each other except for the connection of the generator 170 with the water discharge selector 180. Accordingly, in this embodiment, the flow paths P connecting components to each other may be focused on the flow path guide pack 100. Additionally, the flow paths P may be placed on the same plane, as described above. Therefore, a front-to-back thickness occupied by each of the flow paths P may be reduced, and each of the flow paths P may be made to have the same wide diameter.

FIG. 18 illustrates a state in which the selection point 116 through which purified water discharged through the water discharge selector 180 is discharged and the water discharge point 117 are enlarged. The third selection point 116c and the water discharge point 117 may be connected to each other by the third outflow path P5c. The water discharge point 117 may be connected to the third outlet OH3, and the third outlet OH3 may be a part that discharges the remaining water of the water supply device 10. For example, the residual water of the filter 160, the residual water of the first water discharge part 2, and the residual water of the second water discharge part 4 may be discharged through the water discharge point 117. In this case, a user may open the third selection flow path by manipulating a third selection lever 190c of the water discharge selector 180. Residual water that has passed through the third selection flow path and the outflow paths may be discharged through the third outlet OH3.

Reference numeral H1 denotes the height of the water discharge point 117. On the basis of the water discharge point 117, residual water remaining up to a position higher than the water discharge point 117 may be discharged to the third outlet OH3 through the water discharge point 117. In this case, the water discharge point 117 may be arranged at a position higher than the first selection point 116a which is a second end part of the first outflow path P5a relative to the direction of gravity (a vertical direction based on FIG. 18), the second selection point 116b which is a second end part of the second outflow path P5b, and the third selection point 116c. Accordingly, residual water at the height of the first selection point 116a, the second selection point 116b, and the third selection point 116c may not be discharged immediately, but may move to the water discharge point 117 through the third outflow path P5c to be discharged. Accordingly, when the water supply device 10 stops operating, residual water may be prevented from leaking little by little. In addition, since the water discharge point 117 is arranged higher than the first selection point 116a and the second selection point 116b, the water discharge point 117 may not interfere with the selection points 116.

Looking at the controller, the controller may include the thermostat 140 and the flow rate controller 150. Referring to FIGS. 5 and 6, the thermostat 140 may be provided with the first inlet pipe 142a, the second inlet pipe 142b, and the discharge pipe 142c. Cold water may flow into the first inlet pipe 142a. The first inlet pipe 142a may be connected to the first inflow path P1a of the flow path guide pack 100. More precisely, the first inlet pipe 142a may be connected to the first inlet point 112a of the first inlet pipe 142a. Hot water may flow into the second inlet pipe 142b. The second inlet pipe 142b may be connected to the second inflow path P1b of the flow path guide pack 100. More precisely, the second inlet pipe 142b may be connected to the second inlet point 112b of the second inlet pipe 142b. The cold water, hot water, or mixed water may be discharged through the discharge pipe 142c. The discharge pipe 142c may be connected to the mixed water discharge point 112c of the mixed water flow path P2.

A first knob connection part 143 may be provided on the front surface of the thermostat 140. The first knob connection part 143 may be connected to the first knob 40. The first knob connection part 143 may be configured as a kind of gear.

The thermostat 140 may mix incoming cold water and hot water to control a temperature of mixed water. In this case, the thermostat 140 may be regarded as a kind of valve. In this embodiment, the thermostat 140 may implement a constant temperature function that maintains the temperature of the mixed water around a set temperature. The thermostat 140 may control the ratio of cold and hot water mixed by controlling the degree of the opening of a valve that opens and closes inside.

The flow rate controller 150 may control the discharge amount of mixed water and transmit the controlled mixed water to the filter 160. The flow rate controller 150 may be provided with the control inlet 152a and the control outlet 152b. The mixed water may flow into the control inlet 152a. Controlled water of a flow rate controlled inside the flow rate controller 150 may be discharged through the control outlet 152b. The control inlet 152a may be connected to the flow rate control point 113a of the mixed water flow path P2. The control outlet 152b may be connected to the controlled water discharge point 113b of the flow path guide pack 100. The controlled water discharge point 113b may be provided at one end of the filter flow path P3. Controlled water discharged to the controlled water discharge point 113b may move along the filter flow path P3.

A second knob connection part 153 may be provided on the front surface of the flow rate controller 150. The second knob connection part 153 may be connected to the second knob 50. The second knob connection part 153 may be configured as a kind of gear. Reference numeral 155 denotes a front fastening part. The front fastening part 155 may be coupled to the cover plate 30 through a separate fastener (not shown). The front fastening part 155 may protrude toward the cover plate 30.

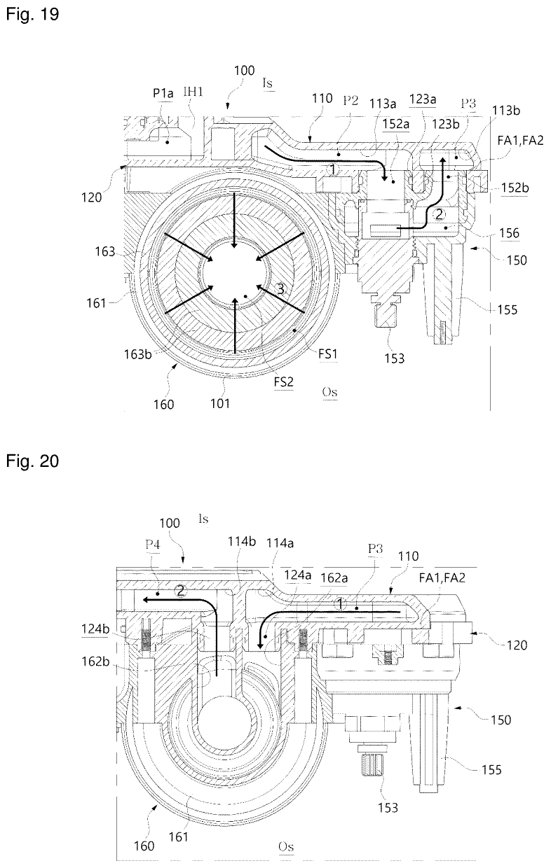

FIGS. 19 to 23 illustrate the structure of the filter 160. First, referring to FIGS. 19 and 20, the filter 160 may include a filter housing 161 having a filter storage part 161a provided therein. The filter housing 161 may be arranged inside the flow path guide pack 100. The filter housing 161 may be approximately cylindrical in shape. The filter storage part 161a of the filter housing 161 may also have a cylindrical shape.

The filter storage part 161a may be open downward. Accordingly, the filter part 163 may be stored in the filter storage part 161a in the second direction different from the first direction in which the first flow path body 110 and the second flow path body 120 are coupled to each other. Here, the second direction may be a direction orthogonal to the first direction, or a direction oblique to the direction orthogonal to the first direction.

The filter housing 161 may be provided with at least one filter mounting part 161′. A fastener (not shown) may be inserted into the filter mounting part 161′. The fastener passing through the filter mounting part 161 may be assembled with the first flow path body 110 of the flow path guide pack 100. A filter assembly part 161″ may be provided on the lower end of the filter housing 161. The filter assembly part 161″ may be provided on the inner surface of the filter housing 161, that is, on the surface of the filter storage part 161a. The filter assembly part 161″ may have a threaded structure so that the filter part 163 can be screwed.

The filter housing 161 may include the filter inlet 162a and the filter outlet 162b. The filter inlet 162a and the filter outlet 162b may be provided on the upper portion of the filter housing 161. The filter inlet 162a and the filter outlet 162b may each be open toward the flow path guide pack 100. The filter inlet 162a may be disposed to be biased toward the edge of the filter housing 161 compared to the filter outlet 162b. Controlled water introduced into the filter inlet 162a may be introduced into a first filter space FS1 of the filter part 163 and discharged to a second filter space FS2 through a filter body 163b to be purified.

The filter part 163 may be stored in the filter storage part 161a. The filter part 163 may include an inner housing 163a and the filter body 163b stored in the inner housing 163a. A filter entrance 164 may be provided on the top of the inner housing 163a. The filter entrance 164 may include a raw water inlet 164a and a purified water outlet 164b connected to the filter inlet 162a and the filter outlet 162b, respectively. The raw water inlet 164a and the purified water outlet 164b may be concentric. The controlled water introduced through the raw water inlet 164a may be purified and then discharged to the purified water outlet 164b.

The filter body 163b may function to purify the controlled water. The filter body 163b may serve to remove chlorine and heavy metals contained in the controlled water. The filter body 163b may also remove bacteria and fine particles contained in the controlled water. The filter body 163b includes one or more of a sediment filter 160, a pre-carbon filter 160, and a membrane filter 160. The sediment filter 160 may remove relatively large debris and impurities such as suspended solids, sand, and rust, and may protect the pre-carbon filter 160. In addition, the pre-carbon filter 160 may remove volatile organic substances, and adsorb and remove chlorine and trihalomethane (THM). The membrane filter 160 is intended to remove fine substances and may include microfiltration (MF), ultrafiltration (UF), reverse osmosis (RO), etc. depending on the size of pores.

The interior of the inner housing 163a may be divided into the first filter space FS1 at an outer side and the second filter space FS2 at an inner side relative to the filter body 163b. Controlled water introduced into the first filter space FS1 may be filtered while passing through the filter body 163b and then discharged to the second filter space FS2. The first filter space FS1 may be connected to the raw water inlet 164a. The second filter space FS2 may be connected to the purified water outlet 164b.

The filter cover 165 may be provided on the lower end of the filter part 163. The filter cover 165 may be provided to be integrated with the inner housing 163a. The filter cover 165 may be exposed to the lower part of the casing 20 when the filter 160 is mounted on the water supply device 10. The filter cover 165 may be provided with the handle 165′. The handle 165′ may be gripped and rotated when a user replaces the filter part 163. Reference numeral 165″ denotes a relative assembly part assembled to the filter assembly part 161″. The relative assembly part 165″ may have a thread structure corresponding to the filter assembly part 161″.

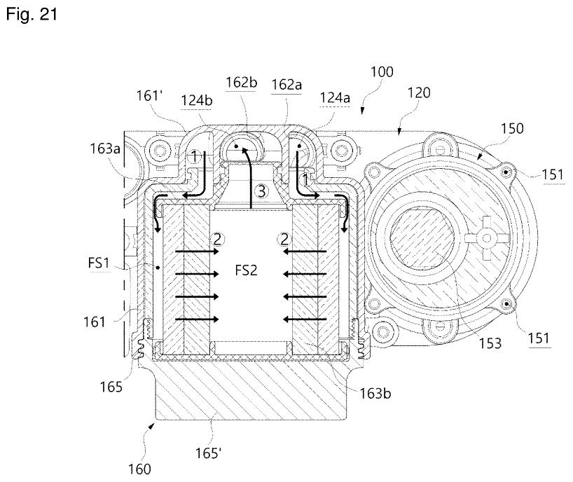

FIG. 21 illustrates a state in which mixed water is introduced into the flow rate controller 150 and a state in which control water is purified through the filter body 163b. The mixed water may flow into the flow rate controller 150 through the mixed water flow path P2 (the direction of arrow \textcircled{1}). The mixed water moving along the mixed water flow path P2 may flow into the control inlet 152a of the flow rate controller 150 through the flow rate control point 113a. Controlled water whose flow rate is controlled in the flow rate controller 150 may be discharged to the control outlet 152b of the flow rate controller 150 (the direction of arrow \textcircled{2}). The controlled water may move along the filter flow path P3 from the controlled water discharge point 113b.

The left side of FIG. 21 illustrates a direction in which the controlled water passes through the filter body 163b (the direction of arrow \textcircled{3}). Water moving toward the center of the filter part 163 through the filter body 163b may be purified while passing through the filter body 163b. The purified water purified in this way may be supplied to the generator 170.

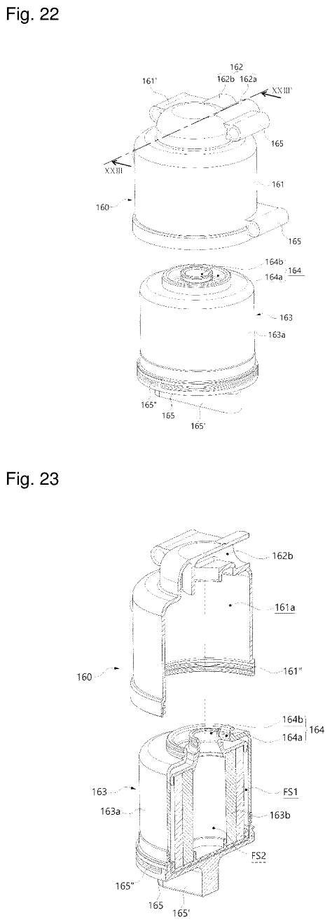

FIG. 22 illustrates a state in which the controlled water enters and exits the filter 160. Controlled water moving through the filter flow path P3 may reach the filter introduction point 114a, and then may flow into the filter inlet 162a of the filter 160 (the direction of arrow \textcircled{1}). Water purified through the filter 160 may be discharged through the filter outlet 162b (the direction of arrow \textcircled{2}). The discharged purified water may be supplied to the generator 170 through the transmission flow path P4 starting at the filter discharge point 114b.

Referring to FIG. 23, the purification of controlled water through the filter 160 is illustrated in detail. The controlled water may be introduced through the filter inlet 162a and then flow into the raw water inlet 164a of the inner housing 163a. The introduced controlled water may flow into the first filter space FS1 (the direction of arrow \textcircled{1}). The controlled water in the first filter space FS1 may pass through the filter body 163b and be discharged to the second filter space FS2 (direction of arrow \textcircled{2}). In this process, the controlled water may be purified. Finally, purified water in the second filter space FS2 may be discharged through each of the purified water outlet 164b of the inner housing 163a and the filter outlet 162b of the filter housing 161.

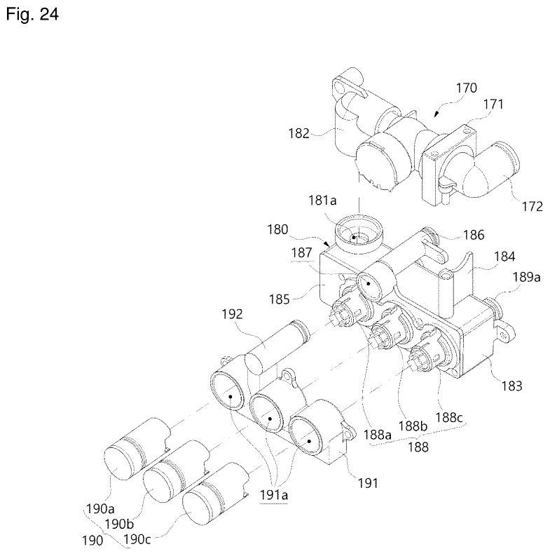

FIGS. 24 to 26 illustrate the generator 170 and the water discharge selector 180. Looking at the generator 170, the generator 170 may be a water-flow generator 170 that uses high-speed water flow caused by the flow of purified water. Although not shown, the inside of the generator 170 may include an impeller that is rotated by pressure of purified water and a small power generation means connected to the impeller. Electrical energy generated by the power generation means may be transferred to a battery. The generator 170 may have a built-in battery, or the display 70 may be provided with a battery. The generator 170 and the display 70 may be electrically connected to each other through a wire (not shown).

The generator 170 may be provided with the power generation inlet 172 and a power generation outlet 182. The power generation inlet 172 may be a part through which purified water is introduced, and the power generation outlet 182 may be a part through which purified water that has completed power generation is discharged. The power generation inlet 172 may be connected to the power supply point 115 (see FIG. 14) of the transmission flow path P4. Reference numeral 171 may be a fixing bracket 171 for fixing the generator 170. The fixing bracket 171 may be fixed to a mounting plate 184 of the water discharge selector 180. The power generation outlet 182 may be regarded as a part of the water discharge selector 180.

The power generation outlet 182 may be open downward. The power generation outlet 182 may be connected to a selector entrance 181a of the water discharge selector 180. That is, since the power generation outlet 182 and the selector entrance 181a are directly connected to each other, the generator 170 and the water discharge selector 180 may be connected to each other without going through the flow path guide pack 100. For another example, the power generation outlet 182 and the selector entrance 181a may each be connected to the flow path guide pack 100 and connected to each other by the flow path guide pack 100.

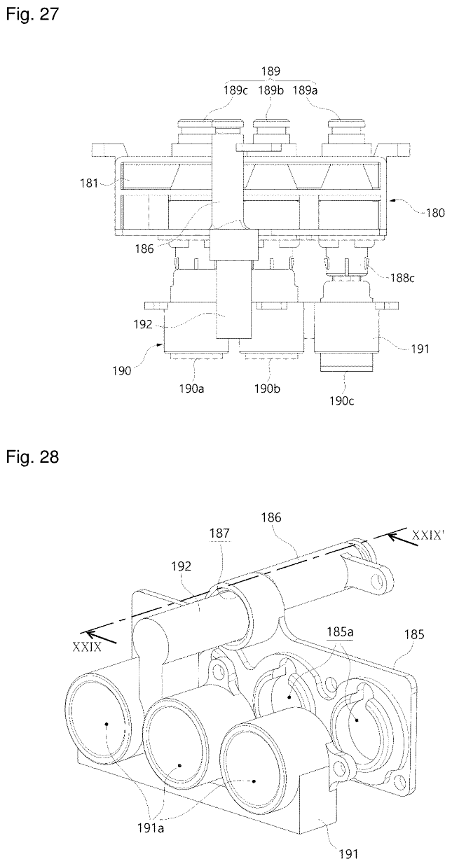

Referring to the water discharge selector 180, the water discharge selector 180 may be provided with a selector housing 183 having a water storage space 181 (see FIG. 27) provided therein. The selector housing 183 may be made into an approximately hexahedral structure. The selector entrance 181a may be open on an upper portion of the selector housing 183. The selector entrance 181a may be connected to the water storage space 181a. The selector housing 183 may be provided with the mounting plate 184 to support the fixing bracket 171 of the generator 170.

Accordingly, in this embodiment, the generator 170 and the water discharge selector 180 may be arranged at different heights. When the generator 170 and the water discharge selector 180 are stacked in a vertical direction, a total volume occupied by the generator 170 and the water discharge selector 180 in the installation space 23 may be reduced. When the generator 170 and the water discharge selector 180 are stacked in the vertical direction, a short flow path that directly connects the generator 170 and the water discharge selector 180 to each other may be formed.

A selector cover 185 may be provided on the front of the selector housing 183. The selector cover 185 may have a flat plate structure. The selector cover 185 may cover the front surface of the selector housing 183. Referring to FIG. 28, the selector cover 185 may be provided with a plurality of holes. The holes, which are lever passage holes 185a, may be parts through which the selection levers 190 pass.

The selector cover 185 may be provided with the selector water discharge pipe 186. The selector water discharge pipe 186 may extend in the front-to-rear direction on the upper portion of the selector cover 185. A connection channel 187 may be provided inside the selector water discharge pipe 186. The connection channel 187 may be connected to the water discharge point 117 of the third outflow path P5c. The connection channel 187 may be connected to the guide water discharge pipe 192 of the movement guide 191. Accordingly, purified water that has passed through the third outflow path P5c and the connection channel 187 may be discharged through a guide channel 192a of the guide water discharge pipe 192. As previously described, since the third outlet (see FIG. 29) is provided on one end part of the guide water discharge pipe 192, purified water may ultimately be discharged through the third outlet OH3.

The selector housing 183 may be provided with a plurality of flow path blocks 188. The flow path blocks 188 may move linearly in front-to-rear directions or rotate. When the flow path blocks 188 move linearly or rotate, selection flow paths (not shown) provided in the flow path blocks 188 may be selectively connected to the water storage space 181a. The selection flow paths connected to the water storage space 181a may receive purified water and transmit the purified water to the outflow path.

In this embodiment, a total of three flow path blocks may be included. The selection flow paths P provided in the three flow path blocks 188, respectively, may be connected to the first outflow path P5a, the second outflow path P5b, and the third outflow path P5c, respectively. The three flow path blocks 188 may connected to the three selection levers 190, respectively, and may be operated by the selection levers 190.

More precisely, a first flow path block 188a among the flow path blocks 188 may be provided with a first selection flow path connected to the first end part of the first outflow path P5a. A second flow path block 188b among the flow path blocks 188 may be provided with the second selection flow path connected to the first end part of the second outflow path P5b. A third flow path block 188c among the flow path blocks 188 may be provided with the third selection flow path connected to the first end part of the third outflow path P5c.

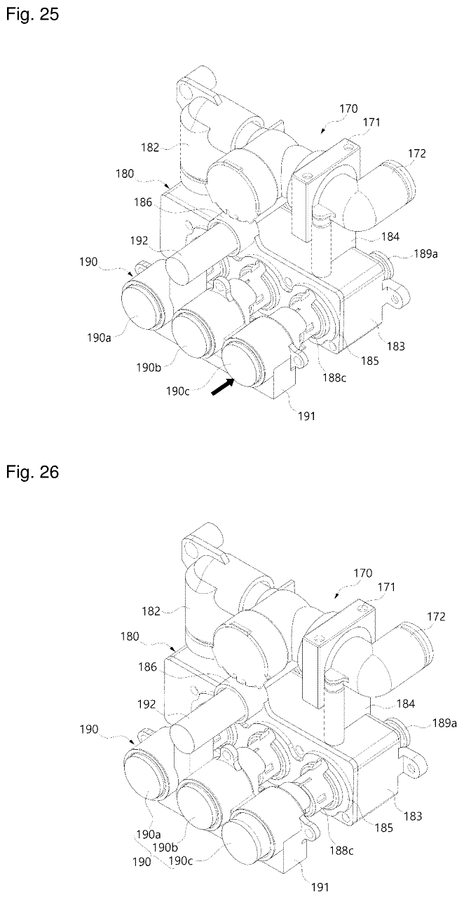

Referring to FIGS. 25 and 26, when a user presses the third selection lever 190c in the direction of an arrow, the third selection lever 190c may protrude forward. Together with the third selection lever 190c, the third flow path block 188c on a rightmost side may also protrude forward. In this case, a connection flow path provided in the third flow path block 188c may be connected to the water storage space 181a. In this embodiment, each of the flow path blocks may be provided with a spring (not shown), and the spring may provide an elastic force to each of the selection lever and the flow path block so that the selection lever and the flow path block protrude forward.

Referring to FIG. 27, the selector housing 183 may be provided with the selector outlets 189. The selector outlets 189 may be connected to the selection flow paths of the flow path blocks 188, respectively. The selector outlets 189 may be connected to the outflow paths P5a, P5b, and P5c. Accordingly, the selector outlets 189 may connect the selection flow paths with the outflow paths P5a, P5b, and P5c.

The selector outlets 189 may include the first selector outlet 189a, the second selector outlet 189b, and the third selector outlet 189c. The first selector outlet 189a may be connected to the first selection point 116a (see FIG. 14). The second selector outlet 189b may be connected to the second selection point 116b (see FIG. 14). The third selector outlet 189c may be connected to the third selection point 116c (see FIG. 14).

The selector outlets 189 may have the same heights. However, the first outflow path P5a, the second outflow path P5b, and the third outflow path P5c starting from the first selection point 116a, the second selection point 116b, and the third selection point 116c, respectively, may have different heights in at least some sections. This is intended to prevent the first outflow path P5a, the second outflow path P5b, and the third outflow path P5c from interfering with each other.

Referring to FIGS. 28 and 29, the selector cover 185 and the movement guide 191 are illustrated. The movement guide 191 may guide the movements of the selection levers 190. The movement guide 191 may be arranged on the front of the selector housing 183. In this embodiment, the movement guide 191 may be fixed to the cover plate 30. The movement guide 191 may have a plurality of guide holes 191a, through which each of the selection levers 190 may move in a straight line.

The movement guide 191 may be provided with the guide water discharge pipe 192. The guide water discharge pipe 192 may be arranged on the upper portion of the movement guide 191. The guide water discharge pipe 192 may extend in the front-to-rear direction, that is, in the coupling direction of the first flow path body 110 and the second flow path body 120. The guide channel 192a may be provided inside the guide water discharge pipe 192. The guide channel 192a may be connected to the connection channel 187 of the selector water discharge pipe 186. As illustrated in FIG. 29, when a portion of the guide water discharge pipe 192 is inserted into the selector water discharge pipe 186, the guide channel 192a may be connected to the connection channel 187.

Referring to FIG. 13, the first end of the selector water discharge pipe 186 may be connected to the water discharge point 117 of the third outflow path P5c. The connection channel 187 may be connected to the guide water discharge pipe 192 of the movement guide 191. Accordingly, purified water that has passed through the third outflow path P5c and the connection channel 187 may be discharged through the guide channel 192a of the guide water discharge pipe 192.

Referring to FIG. 29, the guide channel 192a may be formed in an approximately L-shape. The first end of the guide channel 192a may be connected to the connection channel 187. The third outlet OH3 may be provided on the second end of the guide channel 192a. Since the lower water outlet 25 (see FIG. 3) described above is disposed at the lower part of the third outlet OH3, water discharged through the third outlet OH3 may be discharged to a bathtub through the lower water outlet 25.

FIG. 30 illustrates a second embodiment of the water supply device according to the present disclosure 10. As shown, the water supply device 10A may include a water discharge selector 290 that rotates. The water discharge selector 290 can be rotated in the direction of an arrow. When the water discharge selector 290 is rotated, purified water passing through the flow path guide pack 100 may be selectively discharged through the first outlet OH1, the second outlet OH2, or the third outlet (not shown). Reference numeral 290a refers to a bathtub faucet, and the bathtub faucet 290a may be connected to the third outlet disposed inside.

For example, when the water discharge selector 290 is rotated counterclockwise, purified water may be discharged through the first outlet OH1. When the water discharge selector 290 is rotated clockwise, purified water may be discharged through the second outlet OH2. When the water discharge selector 290 is aligned toward the front as shown in FIG. 30, purified water may be discharged through the third outlet. For this operation, a branch valve connected to the water discharge selector 290 may be disposed inside the water supply device 10A.

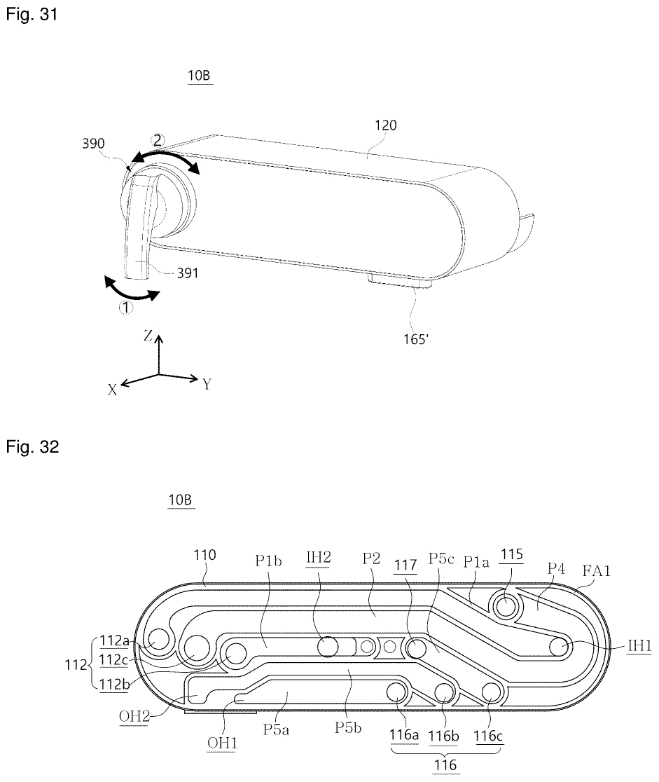

FIGS. 31 and 32 illustrate a third embodiment of a water supply device 10B according to the present disclosure. As illustrated in FIG. 31, the water supply device 10B may include only one control knob 390. The control knob 390 may be rotated in a first direction (a direction of arrow \textcircled{1}) or in a second direction (a direction of arrow \textcircled{2}). The first direction is based on the Y-axis of FIG. 1 as the center of rotation, and the second direction is based on the X-axis of FIG. 1 as the center of rotation.

When the control knob 390 is rotated in the first direction, the controller provided inside the water supply device 10B may control a discharge flow rate. In addition, when the control knob 390 is rotated in the second direction, the controller provided inside the water supply device 10B may control a discharge temperature. Accordingly, in this embodiment, the controller may control both flow rate and temperature. Reference numeral 391 denotes a holding portion of the control knob 390.

FIG. 32 illustrates the structure of the first flow path body 110 of the flow path guide pack 100 constituting the water supply device according to the present disclosure 10B according to the third embodiment. Compared to the first embodiment described above, the flow path for flow rate control is omitted in the flow path guide pack 100. In the third embodiment, the temperature and flow rate of water may be controlled by one controller. To this end, the first flow path body 110 of the flow path guide pack 100 may include the first inflow path P1a and the second inflow path P1b connected to the controller. In addition, mixed water (controlled water) with controlled mixing and flow rate may be supplied to the generator 170 through the mixed water flow path P2 and a power generation path P4. To this end, the power supply point 115 may be provided on an end of the power generation path P4. That is, in this embodiment, unlike the previous embodiment, the filter 160 may be omitted. The mixed water flow path P2 and the power generation path P4 may be regarded as one flow path connected to each other.

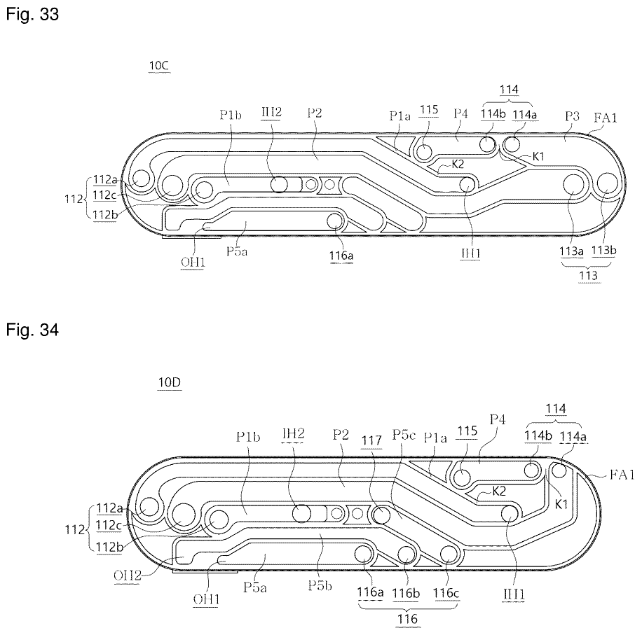

FIG. 33 illustrates the first flow path body 110 of the flow path guide pack 100 constituting a water supply device 10C according to the fourth embodiment of the present disclosure acc. As illustrated in the drawing, the water supply device 10 may be provided with only one outlet OH1. For example, the outlet OH1 may be connected to the handheld shower head 4 (see FIG. 1) through a hose. In this embodiment, since there is only one outlet OH1, the water discharge selector may be omitted.

FIG. 34 illustrates the structure of the first flow path body 110 of the flow path guide pack 100, which constitutes a water supply device 10D according to a fifth embodiment of the present disclosure. Compared to the first embodiment, the flow path connected to the flow rate controller 150 for flow rate control is omitted in the flow path guide pack 100. In the fifth embodiment, the temperature and flow rate of water may be controlled by one controller. To this end, the first flow path body 110 of the flow path guide pack 100 may include the first inflow path P1a and the second inflow path P1b connected to the controller.

In addition, mixed water (controlled water) whose mixing and flow rate are controlled may be supplied to the filter 160 through the mixed water flow path P2. To this end, the filter introduction point 114a may be provided on one end of the mixed water flow path P2. Purified water passing through the filter 160 may be supplied to the generator 170. The following structure is the same as the first embodiment, so description thereof will be omitted.

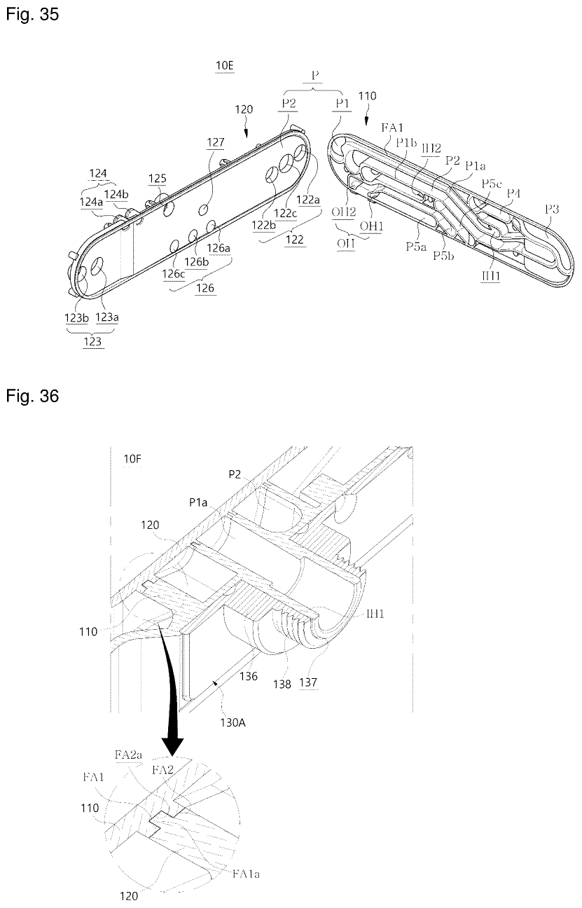

FIG. 35 illustrates the structure of a flow path guide pack 100 constituting a water supply device 10E according to a sixth embodiment of the present disclosure. As illustrated in the drawing, the second path may be omitted in the second flow path body 120 constituting the flow path guide pack 100. The flow paths P of the flow path guide pack 100 may be implemented by the first path P1 of the first flow path body 110. The second flow path body 120 may be combined with the first flow path body 110 and may only serve to cover the flow paths P. Reference numeral P2 indicates the shielding surface of the second flow path body 120 covering the first path P1. Although not shown, in contrast, the flow paths P may be omitted from the first flow path body 110 and may be provided only in the second flow path body 120.

FIG. 36 is a cross-sectional view illustrating the structure of a flow path guide pack 100 constituting a water supply device 10F according to a seventh embodiment of the present disclosure. As illustrated in the drawing, the first flow path body 110 and the second flow path body 120 constituting the flow path guide pack 100 may be provided with the first close contact part FA1 and the second close contact part FA2, respectively, which are in close contact with each other. In this case, a close contact groove FA1a may be recessed in the first close contact part FA1, and a close contact rib FA1b inserted into the close contact groove FA1a may be provided in the second close contact part FA2. Accordingly, an area in which the first close contact part FA1 and the second close contact part FA2 are in contact with each other may be increased. In addition, water or foreign substances may be prevented from entering between the first close contact part FA1 and the second close contact part FA2.

Meanwhile, in this embodiment, the reinforcing plate 130 may be integrally provided with the flange 136. The flange 136 may be fixed to the surface of the reinforcing plate 130. The flange 136 may be welded to the reinforcing plate 130, or may be made by bending a portion of the reinforcing plate 130.

Although not shown, a fixing clip may be coupled to the flow path guide pack 100. The fixing clip may be coupled to the surface of the flow path guide pack 100. The fixing clip may simultaneously cover the first flow path body 110 and the second flow path body 120. The fixing clip may increase a coupling force between the first flow path body 110 and the second flow path body 120.

Additionally, although not shown, a flow path casing 20 may be coupled to the outside of the flow path guide pack 100. The flow path casing 20 may cover the surface of the flow path guide pack 100. The flow path casing 20 may cover the flow path guide pack 100 to increase a coupling force between the first flow path body 110 and the second flow path body 120.

In addition, a temperature sensor and a flow-rate sensor may be provided inside the water supply device 10. The temperature sensor may measure the temperature of water discharged through the thermostat 140 or the water discharge selector 180, and the measured information may be displayed on the display 70. The flow-rate sensor may be provided in the power generation outlet 182 of the generator 170, or the outflow paths P. The flow-rate sensor may measure the flow rate of discharged water, and the measured information may be displayed on the display 70.

The above description is merely an illustrative description of the technical idea of the present disclosure, and those skilled in the art to which the present disclosure belongs may make various modifications and variations without departing from the essential characteristics of the present disclosure. Accordingly, the embodiments disclosed in the present disclosure are not intended to limit but describe the technical idea of the present disclosure, and the scope of the technical idea of the present disclosure is not limited by the embodiments. The scope of protection of the present disclosure should be interpreted in accordance with the claims below, and all technical ideas within the equivalent scope should be interpreted as being included in the scope of the claims of the present disclosure.

Accordingly, the present disclosure has been made to solve the above problems occurring in the related art, and the present disclosure is intended to propose a water supply device in which a flow path guide pack is placed and a flow path independent of the outside is provided between two housings constituting the flow path guide pack.

Another objective of the present disclosure is to propose a water supply device in which a flow path is provided along a portion on which two housings are in close contact with each other, and the flow path is divided by fusion of the portion on which the two housings are in close contact with each other.

Still another objective of the present disclosure is to have a filter mounted inside the water supply device and to have all flow paths connecting hot water/cold water/mixed water with the filter all formed in one flow path guide pack.

Still another objective of the present disclosure is to have a water-flow generator mounted inside the water supply device and to have all flow paths connecting hot water/cold water/mixed water with the water-flow generator formed in one flow path guide pack.

Still another objective of the present disclosure is to ensure that water purified through a filter is supplied to the water-flow generator.

In order to achieve the objectives of the present disclosure as described above, according to the characteristics of the present disclosure, a water supply device of the present disclosure may include a casing having an installation space provided therein. The flow path guide pack may be arranged in the installation space. The flow path guide pack may be provided with an inlet through which water flows in from the outside and an outlet through which water flows out to the outside. The flow path guide pack may include a first flow path body and a second flow path body combined with the first flow path body. In this case, a plurality of flow paths may be formed between the first flow path body and the second flow path body. The flow paths may be paths independent of the installation space. Since water flows through the flow paths of the flow path guide pack, complex flow paths may be implemented without a plurality of hoses.

In addition, a controller that controls the flow rate or temperature of water discharged through the outlet may be placed in the installation space. The flow path guide pack may be provided with a connector connecting the controller and each of the flow paths to each other. The connector may be open in a first direction in which the first flow path body and the second flow path body are coupled to each other. The connector may be provided in each of various locations by utilizing a large area on the front or rear surface of the flow path guide pack.

The controller that controls the flow rate or temperature of water discharged through the outlet may be placed in the installation space. The flow path guide pack may be provided with the connector connecting the controller and each of the flow paths to each other. The connector may be open towards the front surface of the casing.

The plurality of flow paths may be arranged on the same plane inside the flow path guide pack. In this case, while a front-to-rear directional thickness occupied by the flow paths is reduced, the flow paths may be made to have the same wide diameters.

The first flow path body and the second flow path body may include a first close contact part and a second close contact part, respectively. The first close contact part and the second close contact part may be in close contact with each other to form the flow paths. Accordingly, when the first flow path body and the second flow path body are combined with each other, the flow paths may be naturally formed.

In a portion in which the first flow path body and the second flow path body face each other, the flow paths may be formed in the remaining portion except for portions on which the first close contact part and the second close contact part are in close contact with each other. Accordingly, a wide space in which the flow paths are formed may be secured inside the flow path guide pack.

The first close contact part and the second close contact part may be fused to each other by using vibration fusion, heat fusion, or ultrasonic fusion. These fusion methods may allow the flow paths to be formed inside the flow path guide pack without separate fasteners or sealing parts.

The first flow path body and the second flow path body may be combined with each other in the first direction. The inlet may be open in the first direction. The inlet may be made large by utilizing the large area of the front or rear surface of the flow path guide pack, and the inflow of water may be efficiently performed through the inlet.

The first flow path body and the second flow path body may be combined with each other in the first direction. The flow paths may be formed in a direction different from the first direction. Accordingly, while the flow paths are ensured wide, the flow path guide pack may be made thin.

The first flow path body and the second flow path body may be combined with each other in the first direction. The outlet may be open in a second direction orthogonal to the first direction.

A close contact groove may be recessed in the first close contact part. A close contact rib inserted into the close contact groove may be provided in the second close contact part. The close contact groove and the close contact rib may increase the contact area of the first close contact part and the second close contact part.

The flow paths may be formed by being recessed on the surface of the first flow path body facing the second flow path body or on the surface of the second flow path body facing the first flow path body.

The controller that controls the flow rate or temperature of water discharged through the outlet and a filter that purifies water introduced through the inlet may be arranged in the installation space. The flow path guide pack may be provided with connectors connected to the controller and the filter. The connectors may be open in the first direction in which the first flow path body and the second flow path body are coupled to each other.

The controller that controls the flow rate or temperature of water discharged through the outlet and the filter that purifies water introduced through the inlet may be arranged in the installation space. On the basis of a front-to-rear direction, which is the assembly direction of the first flow path body and the second flow path body, each of the controller and the filter may be entirely or partially arranged to overlap the front surface of the flow path guide pack. Accordingly, the flow path guide pack and components may be efficiently arranged in a narrow space.

The flow paths may include an inflow path connecting the inlet with the controller, a filter flow path connecting the controller with the filter, and an outflow path connecting the filter with the outlet. The inflow path, the filter flow path, and the outflow path may be provided on the same plane.

A generator that generates electricity by the hydraulic pressure of the introduced water may be placed in the installation space. The controller, the filter, and the generator may be connected to each other through the flow paths.

In water flow paths formed by the flow paths, the filter may be arranged closer to the inlet than the generator, so that water purified through the filter may be transmitted to the generator. Accordingly, the generator may be prevented from being damaged by impurities contained in water.

The inlet may include a first inlet to which external cold water is supplied and a second inlet to which external hot water is supplied. The flow paths may include a first inflow path connecting the first inlet and the controller to each other. The flow paths may further include a second inflow path that is independent of the first inflow path and connects the second inlet and the controller to each other. The flow paths may further include a mixed flow path having one end connected to the controller and configured to transmit the cold water, the hot water, or the mixed water of the cold water and the hot water toward the outlet.

The flow path guide pack may be arranged in a first area of the installation space. The controller, the filter, and the generator may be arranged in a second area of the installation space. The second area may be arranged closer to the front surface of the casing than the first area.

The controller may include a thermostat that mixes cold water and hot water introduced through the inlet. The controller may include a flow rate controller that controls the discharge amount of water transmitted from the thermostat. The thermostat and the flow rate controller may each be connected to the flow path guide pack. The mixed flow path provided in the flow path guide pack may connect the thermostat and the flow rate controller to each other.

The filter may be arranged in the installation space, and the thermostat and the flow rate controller may be arranged on opposite sides of the filter with the filter as a center thereof.

The filter may be arranged in the installation space. The filter may receive water that has passed through the controller through the flow path guide pack. Water purified through the filter may be transmitted to the outlet through the flow path guide pack.

The filter may be stored in the installation space in the second direction different from the first direction in which the first flow path body and the second flow path body are combined with each other.

The filter may include a filter housing having a filter storage part provided therein, and a filter part that is stored in the filter storage part and purifies water. The filter part may be stored in the filter storage part in the second direction different from the first direction in which the first flow path body and the second flow path body are combined with each other.

The outlet may include a plurality of outlets that is independent of each other. A water discharge selector having a plurality of selection flow paths may be arranged in the installation space. Water discharged from the controller may be discharged through any one of the selection flow paths and transmitted to any one of the plurality of outlets.

The generator that generates electricity by the pressure of the introduced water may be arranged in the installation space. The generator and the water discharge selector may be respectively arranged at different heights inside the installation space.

Water discharged from the flow path guide pack may sequentially pass through the generator and the water discharge selector and then be transmitted to the outlet.

A display or a wireless communication module may be arranged in the installation space. The display or the wireless communication module may be operated by receiving power transmitted from the generator.

The water discharge selector may include a first selection flow path connected to a first end part of a first outflow path of the flow path guide pack. The water discharge selector may include a second selection flow path connected to a first end part of a second outflow path of the flow path guide pack. The water discharge selector may include a third selection flow path connected to a first end part of a third outflow path of the flow path guide pack. A second end part of the first outflow path, the second end part of the second outflow path, and the second end part of the third outflow path may each be open at different locations.

The second end part of the third outflow path may be arranged at a position higher than the second end part of the first outflow path and the second end part of the second outflow path relative to the direction of gravity.

The first end part of the third outflow path connected to the third selection flow path may be arranged at a position lower than the second end part of the third outflow path connected to a third outlet among the plurality of outlets relative to the direction of gravity.

The water discharge selector may include a selector housing having a water storage space provided therein. Flow path blocks may be arranged in the selector housing. The selection flow paths may be formed in the flow path blocks. A plurality of selection levers may be connected to the plurality of flow path blocks, respectively. The plurality of selection levers may selectively connect the water storage space with the selection flow paths by operating the flow path blocks. The water discharge selector may include a movement guide that guides the operation of the plurality of selection levers. The movement guide may include a guide water discharge pipe whose first end part is inserted into the flow path guide pack. The guide water discharge pipe may be connected to the third outflow path of the flow path guide pack.

As described above, the water supply device according to the present disclosure and the faucet including the same may have the following effects.

According to the present disclosure, the flow path guide pack that guides the flow of water may be arranged inside the water supply device. The flow path guide pack may be provided with flow paths that are independent of the internal space of the water supply device, allowing water introduced from the outside to be branched and discharged. Since water flows through the flow path of the guide pack, complex flow paths may be implemented without a plurality of hoses. Accordingly, the internal structure of the water supply device may be simplified, and a decrease in a flow rate due to hoses being folded may be prevented.

In addition, in the flow path guide pack, two flow path bodies may be coupled to each other to form flow paths therebetween. The two flow path bodies may be made of resin materials and then may be coupled to each other by a method such as fusion. Accordingly, in the water supply device of the present disclosure, complex flow paths may be implemented without using a casting method, and the cross-sectional area of a flow path may be made wider compared to the volume to facilitate the flow of water, which also has the effect of making the water supply device lighter.

Furthermore, according to the present disclosure, the flow path guide pack may be manufactured by using a fusion method after injection molding, thereby reducing assembly time and being advantageous in mass production.

Additionally, according to the present disclosure, the flow path guide pack may be responsible for the inflow/branch/discharge of water, and thus the internal structure of the water supply device may be simplified even if components such as a filter, a water-flow generator, and a thermostat are mounted in the water supply device.

Particularly, according to the present disclosure, since the flow path guide pack is composed of two flow path bodies with thin flat plate structures, the flow path guide pack may occupy a small volume inside the water supply device and may be arranged in an upright position. Accordingly, a large free space may be secured inside the water supply device, and thus may be used to install various components, thereby adding various functions while miniaturizing the water supply device.

In addition, according to the present disclosure, the plurality of flow paths may be arranged on the same plane inside the flow path guide pack. Accordingly, when the flow paths are arranged on the same plane, a front-to-rear width occupied by the flow paths may be maintained constant, thereby allowing the flow path guide pack to be miniaturized. In addition, when the flow paths are arranged on the same plane, an excessively bent portion in the flow paths may be eliminated, thereby allowing water to flow efficiently.

Additionally, according to the present disclosure, the inlet of water may be open in the same direction as the first direction in which the first flow path body and the second flow path body constituting the flow path guide pack are assembled with each other. The inlet may be made to be large by utilizing the large area of the front or rear surface of the flow path guide pack. Accordingly, water may be efficiently introduced through the inlet, and water pressure around the inlet may be reduced, thereby increasing the durability of the flow path guide pack.

Furthermore, according to the present disclosure, the flow path guide pack may be detachably arranged inside the water supply device, so when the flow paths are blocked or damaged, only the flow path guide pack may be removed and replaced. That is, the maintainability of the water supply device may be high since only the flow path guide pack is replaced without the need to replace the entirety of water supply device.

In addition, according to the present disclosure, the filter may be placed inside the water supply device to discharge incoming water after purifying the incoming water. Since the filter is arranged inside the body of the water supply device rather than a final discharge device such as a shower head, there is no need to install a filter on each of a plurality of discharge devices. Therefore, the number of parts (filters) for purification may be reduced, and replacement of the filter may become easier.

Particularly, according to the present disclosure, the filter may be mounted upward from the lower portion of the water supply device. Accordingly, the replacement of the filter may be facilitated, and since the entrance of the filter is usually covered, aesthetics may be improved.

Furthermore, since the flow path guide pack takes charge of the flow paths, the wide internal space of the water supply device may be secured, so the capacity of the filter may be increased. Accordingly, the replacement cycle of the filter may be increased, and usability of the water supply device may be improved.

Additionally, according to the present disclosure, the water-flow generator may be installed in the water supply device. The water-flow generator may use water pressure to generate electrical energy and can supply the electrical energy to the display. According to the present disclosure, since the water-flow generator is arranged inside the main body of the water supply device rather than the final discharge device such as the shower head, the water-flow generator may provide various information to a user through the display of the body or utilize communication means or lighting devices.

In addition, according to the present disclosure, in the water flow paths, the water-flow generator may be arranged behind the filter, so that the generator may be operated by purified water. In this case, water from which impurities have been removed may be supplied to the water-flow generator, so the durability of the water-flow generator may be improved.

Additionally, according to the present disclosure, the water discharge selector may be arranged between the flow path guide pack and the outlet, so the discharge direction of water may be selected. For example, a user may discharge water through any one of a handheld showerhead, rain showerhead, or bathtub faucet. In the present disclosure, rather than controlling the discharge direction of water that has already been discharged to the outside of the water supply device, the discharge direction of water may be determined in advance inside the water supply device. Accordingly, before the pressure of water increases, the discharge direction of the water may be selected, so a force required to manipulate the water discharge selector may be reduced and convenience of use may be improved.

Furthermore, according to the present disclosure, inside the water supply device, the water-flow generator and the water discharge selector may be arranged to have a stacked structure at different heights. Since water that has passed through the water-flow generator is directly supplied to the water discharge selector, a flow path connecting the water-flow generator and the water discharge selector to each other may be implemented to have a minimum length, and the internal space of the water supply device may also be utilized effectively.

In addition, according to the present disclosure, the water supply device may be provided with a thermostat that controls the temperature of water and a flow rate controller that controls a flow rate. In this case, the thermostat and the flow rate controller may be arranged symmetrically on opposite ends of the body of the water supply device, and through this, the water supply device may provide a unified aesthetics.

Additionally, the filter, the water-flow generator, and the water discharge selector may be arranged in an empty space between the thermostat and the flow rate controller. Through this arrangement, the internal space of the water supply device may be utilized efficiently.

In addition, according to the present disclosure, residual water remaining in the flow path and the shower head may be discharged in a direction desired by a user through the water discharge selector. In this case, when the bathtub faucet is selected, the residual water may be efficiently discharged through the bathtub faucet, which is placed relatively low, even without lowering the height of the shower head.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A water supply device comprising:
a casing that forms a casing space; and
a flow path guide pack disposed in the casing space,
wherein the flow path guide pack comprises:
a first body; and
a second body coupled to the first body in a first direction so as to form a plurality of flow paths between the first body and the second body.

2. The water supply device of claim 1, wherein the flow path guide pack comprises:
an inlet configured to introduce water from outside the water supply device, and
an outlet configured to discharge water to the outside of the water supply device,
wherein the inlet is connected to the outlet via the flow paths.

3. The water supply device of claim 1, wherein the flow paths are formed inside the flow path guide pack so to be separated from the casing that forms the casing space.

4. The water supply device of claim 1, comprising:
a controller disposed in the casing space and configured to control a flow rate or temperature of water discharged to outside of the flow path guide pack, and
a connector disposed in the flow path guide pack and configured to couple the controller to the flow paths, wherein the connector is open in the first direction.

5. The water supply device of claim 1, wherein the plurality of flow paths are arranged on a same plane inside the flow path guide pack.

6. The water supply device of claim 1, wherein the first body has a first body part and the second body has a second body part, wherein the first body part and the second body part are in close contact with each other to form the flow paths.

7. The water supply device of claim 1, wherein each of the flow paths extends along a direction different from the first direction.

8. The water supply device of claim 1, wherein an inlet configured to provide water from outside the water supply device to inside the flow path guide pack, wherein the inlet is open in the first direction, and
wherein an outlet configured to discharge water from the flow path guide pack to the outside of the water supply device, and the outlet is open in a second direction orthogonal to the first direction.

9. The water supply device of claim 1, comprising:
a controller disposed in the casing space and configured to control a flow rate or a temperature of water discharged to outside of the flow path guide pack, and
a filter disposed in the casing space and configured to purify water introduced into the flow path guide pack,
wherein connectors are provided at the flow path guide pack to couple to the controller and to the filter, wherein the connectors are open in the first direction.

10. The water supply device of claim 1, comprising:
a controller disposed in the casing space and configured to control a flow rate or a temperature of water discharged to outside of the flow path guide pack, and
a filter disposed in the casing space and configured to purify water introduced into the flow path guide pack, and
each of the controller and the filter is disposed at least partly to overlap a front surface of the flow path guide pack.

11. The water supply device of claim 9, wherein the flow path guide pack includes an inlet through which water is introduced and an outlet through which water is discharged,
the flow paths include:
an inflow path coupling the inlet to the controller;
a filter flow path coupling the controller to the filter; and
an outflow path coupling the filter to the outlet,
wherein the inflow path, the filter flow path, and the outflow path are provided on a same plane.

12. The water supply device of claim 1, comprising:
a controller configured to control a flow rate or a temperature of water discharged to outside of the flow path guide pack,
a filter configured to purify water introduced into the flow path guide pack, and
a generator disposed in the casing space and configured to generate electricity based on pressure of the introduced water, wherein the controller, the filter, and the generator are coupled to each other through the flow paths.

13. The water supply device of claim 4, wherein the flow path guide pack comprises:
a first inlet to receive external cold water, and
a second inlet to receive external hot water, and
the flow paths include:
a first inflow path coupling the first inlet to the controller;
a second inflow path separated from the first inflow path, and coupling the second inlet to the controller; and
a mixed flow path that has one end coupled to the controller and configured to provide the cold water, the hot water, or a mixed water of the cold water and the hot water to an outlet of the flow path guide pack.

14. The water supply device of claim 12, wherein the flow path guide pack is arranged in a first area of the casing space, and
the controller, the filter, and the generator are arranged in a second area of the casing space,
wherein the second area is arranged at a position closer to a front surface of the casing than the first area.

15. The water supply device of claim 4, wherein the controller comprises:
a thermostat coupled to the flow path guide pack and configured to mix cold water and hot water, and
a flow rate controller coupled to the flow path guide pack and configured to control a discharge amount of water from the thermostat,
wherein a mixed flow path provided in the flow path guide pack couples the thermostat to the flow rate controller.

16. The water supply device of claim 4, wherein a filter is arranged in the casing space and is configured to receive water that has passed through the controller, and water purified through the filter is provided through the flow path guide pack to the outside of the flow path guide pack, and
wherein the filter is disposed in the casing space in a second direction different from the first direction.

17. The water supply device of claim 16, wherein the filter comprises:
a filter housing having a filter storage structure; and
a filter purifier stored in the filter storage structure and configured to purify water,
wherein the filter purifier is disposed in the filter storage structure in the second direction.

18. The water supply device of claim 2, wherein the outlet includes a plurality of outlets,
a water discharge selector having a plurality of selection flow paths is disposed in the casing space, and
water introduced through the inlet is discharged through any one of the selection flow paths and is provided to any one of the plurality of outlets.

19. The water supply device of claim 18, wherein a generator that generates electricity based on pressure of the introduced water is disposed in the casing space, and the generator and the water discharge selector are arranged at different heights in the casing space.

20. A water supply device comprising:
a casing that forms a casing space; and
a flow path guide pack arranged in the casing space and provided with an inlet to receive water from outside,
wherein the flow path guide pack comprises:
a first body; and
a second body coupled to the first body, and having a plurality of flow paths formed between the first body and the second body,
wherein the inlet is coupled to the flow paths and is open in a direction in which the first body and the second body are coupled to each other.
